(19) United States
(12) Patent Application Publication
(10) Pub. No.: US 2025/0310171 A1
(43) Pub. Date: Oct. 2, 2025

(54) METHODS AND APPARATUS FOR COMMUNICATING SINGLE CARRIER SIGNALS

(71) Applicant: Huawei Technologies Co., Ltd., Shenzhen (CN)

(72) Inventors: Ming Jia, Ottawa (CA); Jianglei Ma, Ottawa (CA)

(21) Appl. No.: 19/238,084

(22) Filed: Jun. 13, 2025

Related U.S. Application Data
(63) Continuation of application No. PCT/CN2022/139173, filed on Dec. 15, 2022.

(51) Int. Cl. H04L 27/34; H04L 27/38

(52) U.S. Cl. CPC H04L 27/3411; H04L 27/3809

(57) ABSTRACT

A method involves processing a single carrier signal to increase the amplitude of at least some of the samples of the single carrier signal in the frequency domain, and transmitting the single carrier signal.

### CROSS-REFERENCE TO RELATED APPLICATION

This application is a continuation of International Application No. PCT/CN2022/139173, entitled “METHODS AND APPARATUS FOR COMMUNICATING SINGLE CARRIER SIGNALS” and filed on Dec. 15, 2022, the disclosure of which is hereby incorporated by reference in its entirety.

### TECHNICAL FIELD

The present disclosure relates to wireless communications involving, in particular, the generation and processing of single carrier signals.

### BACKGROUND

Integrated sensing and communication (ISAC) can involve the use of the same hardware for sensing signals and communication signals. New developments are proposing the use of the same signals for sensing and communication, such that a communication signal may be used to, for example, measure the distance, direction and/or movement of an object.

### SUMMARY

Sensing and communication signals have different requirements, which makes it challenging to generate a signal that is suitable for both sensing and communication. Single carrier signals may be used to achieve the low Peak-to-Average Power Ratio (PAPR) required for sensing whilst achieving the high data throughput that is desirable for communication. Low PAPR may also be a requirement for communication since it can be a requirement for power amplifiers. However, single carrier signals, such as Discrete Fourier Transform Spread Orthogonal Frequency Division Multiplexing (DFT-S-OFDM) and Single Carrier Offset Quadrature Amplitude Modulation (SC-OQAM), often have poor ambiguity functions. The impact of a poor ambiguity function can be mitigated in processing performed by the receiver. However, this processing can lead to significant and unpredictable noise enhancement.

Aspects of the present disclosure provide a method in which a single carrier signal is processed to clip the notches, that is the troughs, of the single carrier signal in the frequency domain. This may be described as floor clipping in the frequency domain. This can result in the frequency domain representation of the single carrier signal having fewer samples close to zero (e.g. fewer small amplitude samples), which reduces the risk of enhancing noise when processing a reflection of the single carrier signal from an object in order to sense the object. As such, floor clipping a single carrier signal in the frequency domain thus enables providing a high data rate, low PAPR (e.g. compared to OFDM) signal that has a post-processing ambiguity function that is comparable to OFDM. In the context of sensing, this allows for achieving sensing with a higher dynamic range at a lower PAPR. In the context of integrated sensing and communication, this allows for achieving high dynamic range sensing and high data throughput.

In an aspect, a method is provided. The method involves generating a single carrier signal for transmission. The method may involve processing a frequency domain representation of a single carrier signal to obtain a signal for transmission. The frequency domain representation of the single carrier signal may include one or more samples of the single carrier signal at respective subcarriers. A sample of the one or more samples has an amplitude such that a power of the respective sample is no less than a minimum value. Processing the frequency domain representation of the single carrier signal may involve, for a sample of the one or more samples, setting an amplitude of the respective sample to a larger amplitude such that a power of the respective sample is no less than a minimum value. The method involves outputting the signal for transmission. The method may also involve causing the signal to be transmitted.

The method may also involve performing a Fourier transform on the single carrier signal to obtain the frequency domain representation of the single carrier signal. The method may also involve increasing the amplitude of the sample of the one or more samples.

The signal to be transmitted may comprise a sensing signal. The signal to be transmitted may include a communication signal.

The respective sample xᵢ may have a phase θᵢ. Setting the amplitude of the respective sample to the larger amplitude such that the power of the respective sample is no less than the minimum value ρ may involve setting the amplitude of the respective sample according to xᵢ=\sqrt{ρ}e^{jθ}^{ᵢ}.

The single carrier signal may include a Single-Carrier Offset-Quadrature Amplitude Modulation (SC-OQAM) signal or a Discrete Fourier Transform Spread Orthogonal Frequency Division Multiplexing (DFT-S-OFDM) signal.

Processing the frequency domain representation of the single carrier signal to obtain the signal for transmission may involve applying a root raised-cosine window to the frequency domain representation of the single carrier signal.

Causing the signal to be transmitted may involve transmitting the signal or providing the signal to an antenna for transmission.

The method may also involve transmitting an indication of a minimum value.

The method may also involve receiving a reflected signal comprising a reflection of the single carrier signal from an object and determining a sensing estimate for the object based on the reflected signal and the frequency domain representation of the single carrier signal.

Determining the sensing estimate based on the reflected signal and the frequency domain representation of the single carrier signal may involve performing a Fourier transform on the reflected signal to obtain a frequency domain representation of the reflected signal, and dividing the frequency domain representation of the reflected signal by the frequency domain representation of the single carrier signal.

Determining the sensing estimate for the object may involve determining at least one of: a distance to the object, a direction of the object, and movement of the object.

In a further aspect, an apparatus configured to perform the above-mentioned method is also provided. The apparatus may include a processor and a memory (e.g. a non-transitory processor-readable medium). The memory stores instructions (e.g. processor-readable instructions) which, when executed by a processor of an apparatus, cause the apparatus to perform the method above. In another aspect, the memory may be provided (e.g. separate to the apparatus). In another aspect, a computer program product comprising the preceding instructions may be provided.

In another aspect, a method is provided. The method may involve receiving a reflected signal comprising a reflection of a single carrier signal from an object, obtaining a frequency domain representation of the single carrier signal, and determining a sensing estimate based on the reflected signal and the frequency domain representation of the single carrier signal. The frequency domain representation of the single carrier signal may include one or more samples of the single carrier signal at respective subcarriers, in which a sample of the one or more samples may have an amplitude (e.g., an amplitude that is set to a larger amplitude) such that a power of the respective sample is no less than a minimum value.

Determining the sensing estimate based on the reflected signal and the frequency domain representation of the single carrier signal may involve performing a Fourier transform on the reflected signal to obtain a frequency domain representation of the reflected signal, and dividing the frequency domain representation of the reflected signal by the frequency domain representation of the single carrier signal.

Determining the sensing estimate for the object may involve determining at least one of: a distance to the object, a direction of the object, and movement of the object.

The single carrier signal may include an integrated sensing and communication signal.

Obtaining the frequency domain representation of the single carrier signal may involve setting the amplitude of the respective sample to the larger amplitude such that the power of the respective sample is no less than the minimum value.

The respective sample xᵢ may have a phase θᵢ. Setting the amplitude of the respective sample to the larger amplitude such that the power of the respective sample is no less than the minimum value ρ may include setting the amplitude of the respective sample according to

$${x}_{i} = \sqrt{ρ} {e}^{j {θ}_{i}} .$$

The method may also involve receiving an indication of the minimum value.

The single carrier signal may involve an SC-OQAM signal or a DFT-S-OFDM signal.

In a further aspect, an apparatus configured to perform the above-mentioned method is also provided. The apparatus may include a processor and a memory (e.g. a non-transitory processor-readable medium). The memory stores instructions (e.g. processor-readable instructions) which, when executed by a processor of an apparatus, cause the apparatus to perform the method above. In another aspect, the memory may be provided (e.g. separate to the apparatus). In another aspect, a computer program product comprising the preceding instructions may be provided.

In another aspect, an apparatus is provided. The apparatus may include a processor and a memory. The memory may store instructions which, when executed by the processor, cause the apparatus to generate and output a single carrier signal for transmission. The memory may store instructions which, when executed by the processor, may cause the apparatus to process a frequency domain representation of a single carrier signal to obtain a signal for transmission and cause the signal to be transmitted. The frequency domain representation of the single carrier signal may include one or more samples of the single carrier signal at respective subcarriers. A sample of the one or more samples has an amplitude such that a power of the respective sample is no less than a minimum value. Processing the frequency domain representation of the single carrier signal may involve, for a sample of the one or more samples, setting an amplitude of the respective sample to a larger amplitude such that a power of the respective sample is no less than a minimum value.

When the instructions are executed by the processor, the apparatus may be further caused to perform a Fourier transform on the single carrier signal to obtain the frequency domain representation of the single carrier signal. When the instructions are executed by the processor, the apparatus may be further caused to increase the amplitude of the sample of the one or more samples.

The signal to be transmitted may include a sensing signal. The signal to be transmitted may include a communication signal.

The respective sample xᵢ may have a phase θᵢ. When the instructions are executed by the processor, the apparatus may be caused to set the amplitude of the respective sample to the larger amplitude such that the power of the respective sample is no less than the minimum value ρ by setting the amplitude of the respective sample according to

$${x}_{i} = \sqrt{ρ} {e}^{j {θ}_{i}} .$$

The single carrier signal may include an SC-OQAM signal or DFT-S-OFDM signal.

When the instructions are executed by the processor, the apparatus may be caused to process the frequency domain representation of the single carrier signal to obtain the signal for transmission by applying a root raised-cosine window to the frequency domain representation of the single carrier signal.

When the instructions are executed by the processor, the apparatus may be caused to cause the signal to be transmitted by transmitting the signal or providing the signal to an antenna for transmission.

When the instructions are executed by the processor, the apparatus may be further caused to transmit an indication of a minimum value.

When the instructions are executed by the processor, the apparatus may be further caused to receive a reflected signal comprising a reflection of the single carrier signal from an object and determine a sensing estimate for the object based on the reflected signal and the frequency domain representation of the single carrier signal.

When the instructions are executed by the processor, the apparatus may be caused to determine the sensing estimate based on the reflected signal and the frequency domain representation of the single carrier signal by performing a Fourier transform on the reflected signal to obtain a frequency domain representation of the reflected signal, and dividing the frequency domain representation of the reflected signal by the frequency domain representation of the single carrier signal.

When the instructions are executed by the processor, the apparatus may be caused to determine the sensing estimate for the object by determining at least one of: a distance to the object, a direction of the object, and movement of the object.

In another aspect, an apparatus is provided. The apparatus may include a processor and a memory. The memory may store instructions which, when executed by the processor, may cause the apparatus to receive a reflected signal comprising a reflection of a single carrier signal from an object, obtain a frequency domain representation of the single carrier signal, and determine a sensing estimate based on the reflected signal and the frequency domain representation of the single carrier signal. The frequency domain representation of the single carrier signal may include one or more samples of the single carrier signal at respective subcarriers, in which a sample of the one or more samples may have an amplitude (e.g., an amplitude that is set to a larger amplitude) such that a power of the respective sample is no less than a minimum value

When the instructions are executed by the processor, the apparatus may be caused to determine the sensing estimate based on the reflected signal and the frequency domain representation of the single carrier signal by performing a Fourier transform on the reflected signal to obtain a frequency domain representation of the reflected signal, and dividing the frequency domain representation of the reflected signal by the frequency domain representation of the single carrier signal.

When the instructions are executed by the processor, the apparatus may be caused to determine the sensing estimate for the object by determining at least one of: a distance to the object, a direction of the object, and movement of the object.

The single carrier signal may include an integrated sensing and communication signal.

When the instructions are executed by the processor, the apparatus may be caused to obtain the frequency domain representation of the single carrier signal by setting the amplitude of the respective sample to the larger amplitude such that the power of the respective sample is no less than the minimum value.

The respective sample xᵢ may have a phase θᵢ. When the instructions are executed by the processor, the apparatus may be caused to set the amplitude of the respective sample to the larger amplitude such that the power of the respective sample is no less than the minimum value ρ by setting the amplitude of the respective sample according to

$${x}_{i} = \sqrt{ρ} {e}^{j {θ}_{i}} .$$

When the instructions are executed by the processor, the apparatus may be further caused to receive an indication of the minimum value.

The single carrier signal may include an SC-OQAM signal or a DFT-S-OFDM signal.

In another aspect, a method is provided. The method may involve receiving a single carrier signal. The single carrier signal may have been processed in the frequency domain such that a sample in a frequency domain representation of the single carrier signal at a particular subcarrier has an amplitude that has been set to a larger amplitude such that a power of the sample is no less than a minimum value. The method may also involve processing the received single carrier signal.

In a further aspect, an apparatus configured to perform the above-mentioned method is also provided. The apparatus may include a processor and a memory (e.g. a non-transitory processor-readable medium). The memory stores instructions (e.g. processor-readable instructions) which, when executed by a processor of an apparatus, cause the apparatus to perform the method above. In another aspect, the memory may be provided (e.g. separate to the apparatus). In another aspect, a computer program product comprising the preceding instructions may be provided.

In another aspect, an apparatus is provided. The apparatus includes a processor a memory. The memory may store instructions which, when executed by the processor, cause the apparatus to receive a single carrier signal. The single carrier signal may have been processed in the frequency domain such that a sample in a frequency domain representation of the single carrier signal at a particular subcarrier has an amplitude that has been set to a larger amplitude such that a power of the sample is no less than a minimum value. The apparatus may be further caused to process the received single carrier signal.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIGS. 5 and 6 show the ambiguity functions of various signals.

FIG. 7 shows a power spectrum of a Single-Carrier Offset-Quadrature Amplitude Modulation (SC-OQAM) signal before and after floor clipping according to embodiments of the disclosure.

FIG. 8 shows a constellation diagram of a simulated single carrier orthogonal quadrature phase-shift keying (SC-OQPSK) signal after floor clipping according to embodiments of the disclosure.

FIG. 9 shows a complementary cumulative distribution function (CCDF) of the per-symbol base signal-to-interference ratio (SIR) for the simulated SC-OQPSK signal after floor clipping according to embodiments of the disclosure.

FIG. 10 shows the CCDF of noise enhancement of the simulated SC-OQAM signal with and without floor clipping according to embodiments of the disclosure.

FIG. 11 shows the CCDF of the Peak-to-Average Power Ratio (PAPR) of various signals with and without floor clipping according to embodiments of the disclosure.

FIG. 12 shows a system according to an embodiment of the disclosure.

FIGS. 13 and 14 show block diagrams corresponding to flowcharts of methods according to embodiments of the disclosure.

FIG. 15 shows the system according to another embodiment of the disclosure.

FIGS. 16 and 17 show block diagrams corresponding to flowcharts of methods according to embodiments of the disclosure.

FIGS. 18-20 show flowcharts of methods according to embodiments of the disclosure.

### DETAILED DESCRIPTION OF THE ILLUSTRATIVE EMBODIMENTS

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

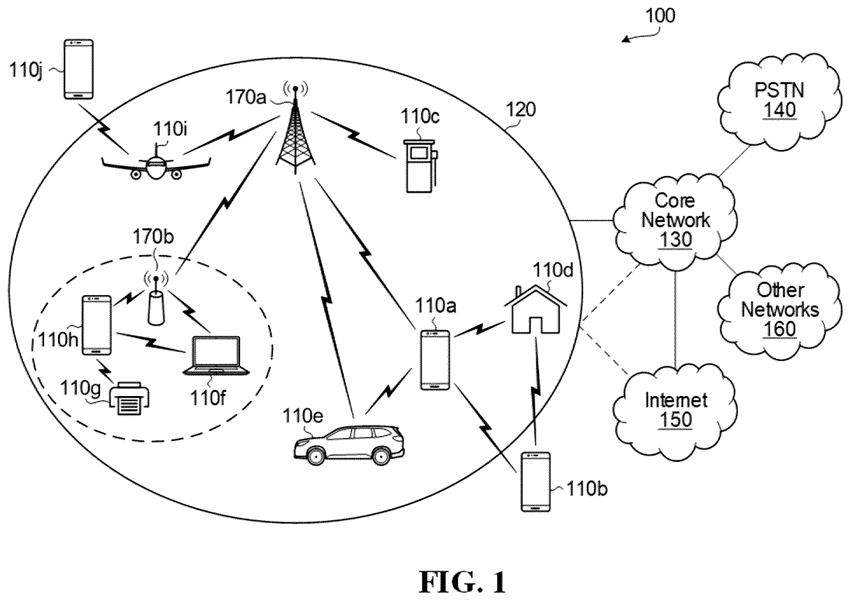

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

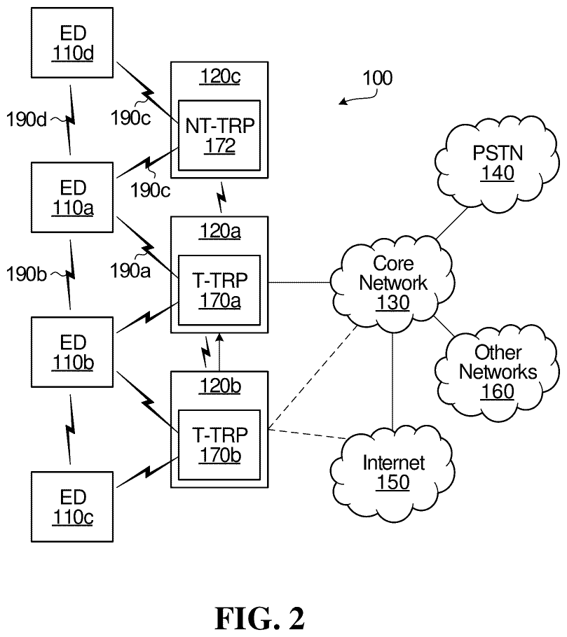

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

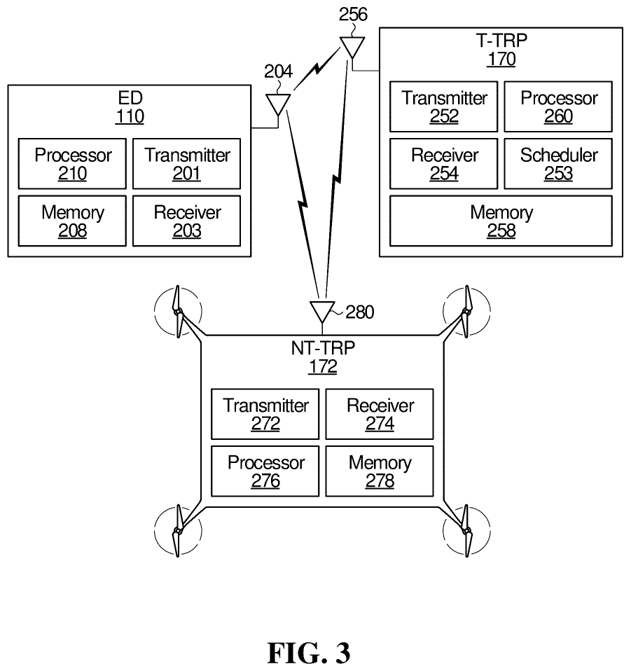

FIG. 3 illustrates another example of an ED no and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e. established, activated, or enabled), turned-off (i.e. released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

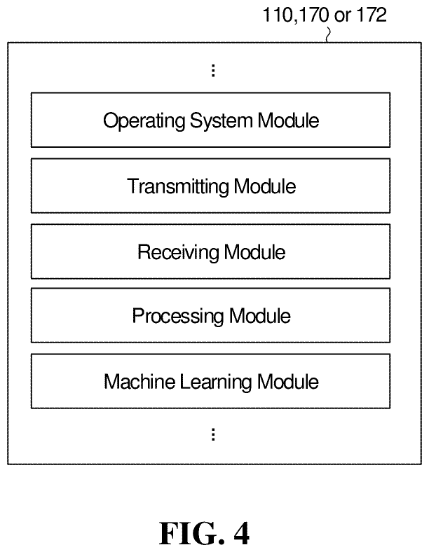

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A sensing system may be used to help gather pose information for a particular object, such as an apparatus. Pose information may include, for example, one or more of: a relative location of the particular object (e.g. with respect to a reference point or other apparatus), location in a global coordinate system, movement of the object (relative or in a global coordinate system), orientation information and the information about the wireless environment. “Location” is also known as “position” and these two terms may be used interchangeably herein. The relative location of the object may include a distance to the object and/or a direction to the object. The movement of the object may include a speed, direction of movement and/or acceleration of the object, for example.

Sensing systems may be particularly useful for obtaining pose information for electronic devices, which may be referred to as ED pose information. ED pose information may be used in cellular communication networks to improve various performance metrics for the network. Such performance metrics may, for example, include capacity, agility and/or efficiency. The improvement may be achieved when elements of the network exploit the position, the behavior, the mobility pattern, etc. of the ED in the context of a priori information describing a wireless environment in which the ED is operating.

Examples of well-known sensing systems include RADAR (Radio Detection and Ranging) and LIDAR (Light Detection and Ranging). While the sensing system is typically separate from the communication system, it could be advantageous to gather the information using an integrated system to reduce the hardware (and cost) in the system as well as the time, frequency or spatial resources needed to perform both functionalities. However, using the communication system hardware to perform sensing of ED pose and environment information is a highly challenging problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and TRPs 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. For example, the system 100 may further include a dedicated sensing agent, which is an example of a sensing node that is dedicated to sensing. Unlike the EDs 110 and TRPs 170, the dedicated sensing agent does not transmit or receive communication signals. However, the dedicated sensing agent may communicate configuration information, sensing information, signaling information, or other information within the communication system 100. In some cases, a plurality of dedicated sensing agents may be implemented and may communicate with each other to jointly perform a sensing task. The dedicated sensing agent may be in communication with the core network 130 to communicate information with the rest of the communication system 100. By way of example, the dedicated sensing agent may determine the location of the ED 110a, and transmit this information to the base station 170a via the core network 130. Although no dedicated sensing agent is shown in FIG. 2, any number of sensing agents may be implemented in the communication system 100. In some embodiments, one or more dedicated sensing agents may be implemented at one or more of the RANs 120.

A sensing node may combine sensing-based techniques with reference signal-based techniques to enhance UE pose determination. Reference signal-based techniques may be considered as a type of bi-static (or multi-static) sensing, particularly when measurements of reference signals are used for pose estimation. This type of sensing node may also be known as a node that implements a sensing management function (SMF). In some networks, the SMF may also be known as a node that implements a location management function (LMF). The SMF may be implemented as a physically independent entity located at the core network 130 with connection to the multiple TRPs 170. In other aspects of the present application, the SMF may be implemented as a logical entity co-located inside a TRP, such as the T-TRP 170, through logic carried out by a processor in the TRP, such as the processor 260.

In one example, an SMF may be implemented as a physically independent entity that includes at least one processor, at least one transmitter, at least one receiver, one or more antennas and at least one memory. A transceiver may be used instead of the transmitter and the receiver. A scheduler may be coupled to the processor of the SMF. The scheduler may be included within or operated separately from the SMF. The processor implements various processing operations of the SMF, such as signal coding, data processing, power control, input/output processing or any other functionality. The processor can also be configured to implement some or all of the functionality and/or embodiments described in more detail above. The processor includes any suitable processing or computing device configured to perform one or more operations. The processor could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g. the electronic device 110) takes part in process of determining the pose of the enquirer. The enquirer may transmit or receive and process (or both transmit and receive/process) a signal that is specific to the pose determination process. Positioning techniques based on a global navigation satellite system (GNSS) such as the known Global Positioning System (GPS) are other examples of the active pose estimation paradigm. Various positioning technologies are also known in NR systems and in LTE systems.

In contrast, a sensing technique, based on radar and/or lidar for example, may be considered as belonging to a “passive” pose determination paradigm. In a passive pose determination paradigm, the target may be oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining ED channel sub-space information, which is particularly useful for ED channel reconstruction at the sensing node, especially for a beam-based operation and communication. The ED channel sub-space is a subset of the entire algebraic space, defined over the spatial domain, in which the entire channel from the TP to the ED lies. Accordingly, the ED channel sub-space defines the TRP-to-ED channel with very high accuracy. The signals transmitted over other sub-spaces result in a negligible contribution to the ED channel. Knowledge of the ED channel sub-space helps to reduce the effort needed for channel measurement at the ED and channel reconstruction at the network-side. Therefore, the combination of sensing-based techniques and reference signal-based techniques may enable the ED channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same channels (e.g. the same PDSCH and PUSCH) could be used for both communication and sensing. Separate logical layer channels and/or transport layer channels may be defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g. Radar and radar) are equally valid and now more common. Radar is typically used for detecting a presence and a location of an object. A radar system radiates radio frequency energy and receives echoes of the energy reflected from one or more targets. The system determines the pose of a given target based on the echoes (also referred to as reflections) returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated. The distance of separation is typically comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-S)-OFDM.

Sensing and communication have different constraints, which has often necessitated the use of different waveforms for sensing and communication. Sensing, for example, has often employed a chirp waveform, such as a linear chirp waveform, whereas communication has employed OFDM.

OFDM is suitable for integrated sensing and communication as it has a high data throughput whilst also being suitable for ranging (distance estimation) and Doppler estimation. However, OFDM results in a transmitted signal with a high Peak-to-Average Power Ratio (PAPR), which can degrade performance. This may be a particular issue for sensing, for which it is desirable to use higher carrier frequencies (to achieve a higher bandwidth and thus a higher resolution) that necessitate a lower PAPR. The efficiency of a power amplifier is often lower at higher frequencies. Using a low PAPR waveform allows for using the power amplifier more efficiently because it requires a smaller linear range to support a given average power (e.g. less peak power back-off is required).

Single carrier signals have been proposed as one approach to reduce PAPR. DFT-S-OFDM is one example of a single carrier waveform that may be used to reduce PAPR. DFT-S-OFDM can achieve the high data throughput of ODFM whilst achieving a lower PAPR than OFDM. Another candidate single carrier waveform is Single Carrier Offset Quadrature Amplitude Modulation (SC-OQAM), which also achieves a lower PAPR than OFDM. However, SC-OQAM and DFT-S-OFDM have poor ambiguity functions.

The ambiguity function of a waveform indicates the extent to which echoes (e.g. reflections) of a waveform interfere with each other. An ideal or perfect ambiguity function resembles a delta function, which means that each echo is localized. When an ambiguity function has a high floor, or includes spikes (e.g. peaks) at non-original locations, there is a risk of false detections occurring or interference with echo detection at those locations. For example, an echo at a lower energy than the floor of the ambiguity function may not be detectable when a larger echo is present. In particular, the detected signal is a (circular) correlation between the transmitted signal and the reflected signal. If there is only one reflection (e.g. one echo), then the detected signal will be an ambiguity function in which the peak location indicates the delay and thus the distance to the reflector. When there are multiple reflections (e.g. multiple echoes), the detected signal will be a superposition of these ambiguity functions. Since the peak of each ambiguity function can be at a different location, if a first reflection has a floor that is higher than the peak of a second reflection, this can make the second reflection undetectable. In the context of radar, the ambiguity function has been defined as the autocorrelation of a waveform in the time domain. However, in the context of single carrier sensing, such as DFT-S-OFDM based sensing or SC-OQAM based sensing, it may be defined as the per-symbol based circular autocorrelation of a waveform.

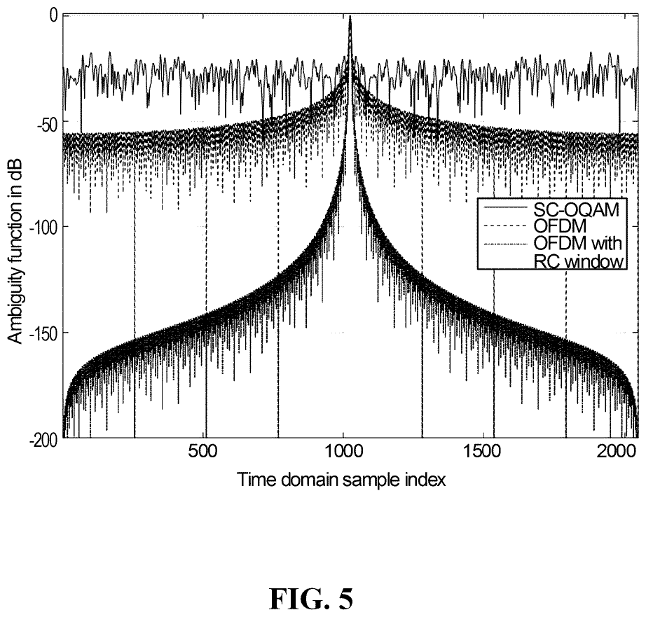

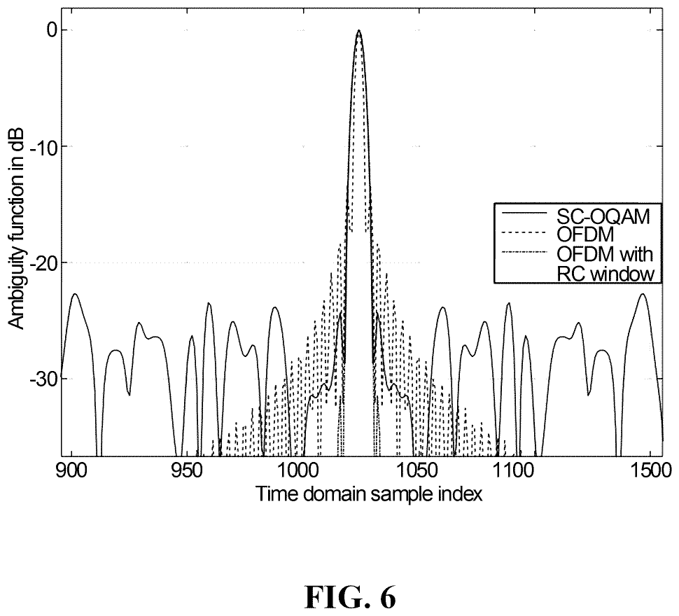

FIG. 5 shows the ambiguity functions (in dB) of an SC-OQAM signal (solid line, top), an OFDM signal (dashed lined, middle) and an OFDM when a raised cosine (RC) window is applied (dot-dashed line, bottom). FIG. 6 shows the same ambiguity functions as FIG. 5, but zoomed in on the main lobe (also referred as the main peak) at a sample index of between 1000 and 1050. The ambiguity function of RC OFDM shown in FIGS. 5-6 may be described as a post-processing ambiguity function since the lower side-lobes are achieved by applying the RC window in the frequency domain (also referred to as frequency domain windowing).

As shown in FIG. 5, the ambiguity function for SC-OQAM is far from a delta function. The upper-envelope of the floor of the ambiguity function for SC-OQAM is around −20 dB, which means the dynamic range of SC-OQAM is very limited. This lack of dynamic range may mean it is difficult to distinguish echoes of SC-OQAM in the presence of noise, attenuation, distortion etc.

In contrast, OFDM has a much larger dynamic range. However, the roll-off speed of the main lobe (e.g. of the main peak in FIG. 5) is slow and the upper-envelope of the floor of the ambiguity function is still high, largely remaining above −50 dB.

To improve the ambiguity function of an OFDM signal, an RC window may be applied to the OFDM signal. As shown in FIG. 5, RC windowed OFDM has an ambiguity function that is very close to an ideal delta function, with a distinct, sharp peak or main lobe. With RC windowing, OFDM can have a very large dynamic range, which means weak echoes may be detected and distinguished (e.g. are separable) even when a very strong echo (a strong peak) is present. Although RC windowed OFDM has very steep side-lobes and very low ambiguity floors, applying a non-matched widow can cause a Signal to Noise Ratio (SNR) loss of about 1.75 dB. In addition, as shown in FIG. 6, the main lobe or peak of a windowed OFDM is slightly wider than the main lobe of OFDM. That is, the peak for RC windowed OFDM is wider than the peak for (non-RC windowed) OFDM. When weak echoes are submerged by the side-lobes of strong echoes, it can make it difficult to detect and distinguish the weak echoes regardless of how high the SNR is. As noted above, RC windowed OFDM is also subject to an SNR penalty of around 1.75 dB compared to (non-RC windowed) OFDM. Even so, the benefit of an ideal ambiguity function may still outweigh the 1.75 dB SNR cost, as sensing usually has high processing gain. The lost SNR may be compensated by using more OFDM symbols for sensing, for example.

However, applying an RC window to single carrier signals such as DFT-S-OFDM and SC-OQAM is not effective in improving the ambiguity function.

Instead, the impact of the poor ambiguity functions of single carrier waveforms such as DFT-S-OFDM and SC-OQAM can be mitigated by performing additional processing at the receiver. In particular, in order to determine, for example, the range of an object, a receiver of reflection of a sensing signal from that object may divide the reflected signal by the sensing signal that was originally transmitted in the frequency domain. This can mitigate the impact of the poor ambiguity function of the signal that was initially transmitted. However, some single carrier waveforms, such as SC-OQAM and DFT-S-OFDM, have power spectra that are not flat. This means that dividing the reflected signal by the sensing signal that was originally transmitted in the frequency domain may involve dividing the reflected signal by values that are close to zero, which can cause significant and uncontrollable noise enhancement.

To overcome this noise-enhancement problem, it has been suggested to use Fast Cyclic Correlation Radar (FCCR) on DFT-S-OFDM for sensing. This effectively involves implementing a time-domain auto-correlation in the frequency domain. Using FCCR on DFT-S-OFDM may avoid the noise-enhancement problem. However, it does not mitigate the impact of the poor ambiguity functions of SC-OQAM and DFT-S-OFDM.

Aspects of the present disclosure provide a method in which a single carrier signal is processed to clip the notches, that is the troughs or lowest values, of the single carrier signal in the frequency domain. This may be described as floor clipping. This can result in the frequency domain representation of the single carrier signal having fewer samples close to zero (e.g. fewer small amplitude samples), which reduces the risk of enhancing noise at the receiver when the receiver divides a reflection of the single carrier signal by the transmitted single carrier signal in order to perform sensing. In addition, clipping the single carrier signal in the frequency domain ensures each sample in the signal stays in its respective bandwidth, which means no additional filtering (e.g. filtering as a result of the clipping) may be required.

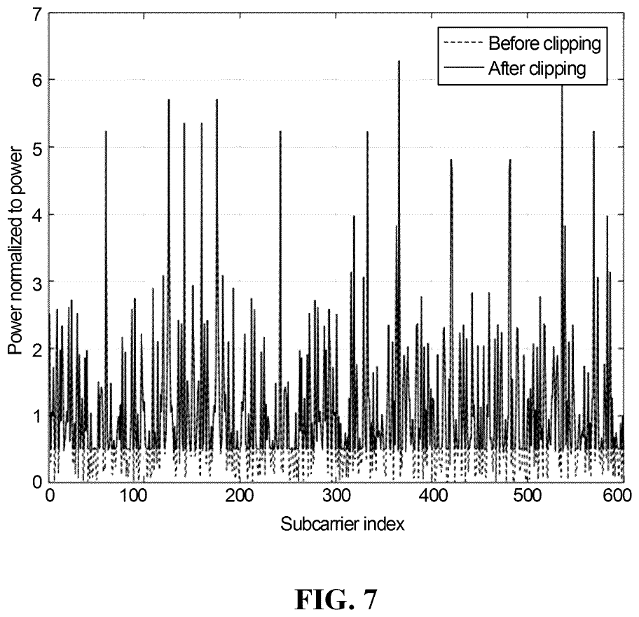

An example of floor clipping an SC-OQAM signal in the frequency domain is shown in FIG. 7. The dotted line shows the power spectrum of the SC-OQAM signal before floor clipping. The solid line, which is overlaid on top of the dotted line, shows the power spectrum of the SC-OQAM of the signal after floor clipping. In this example, the SC-OQAM signal comprises a plurality of samples |xᵢ|e^{jθ}^{ᵢ} in the frequency domain for i=1, . . . , M subcarriers and the SC-OQAM is floor clipped according to

$$for i = 1 : M \qquad ( 1 )$$

$$if {\vert {x}_{i} \vert}^{2} < ρ$$

$${x}_{i} = \sqrt{ρ} {e}^{j {θ}_{i}}$$

$$end$$

$$end$$

in which ρ is a floor applied to the power spectrum. In this example, ρ is set at 3 dB lower than the average power of the SC-OQAM signal. As shown in FIG. 7, by floor clipping the SC-OQAM signal in the frequency domain, a power floor for the SC-OFDM signal is set in the frequency domain, which controls the noise enhancement effect when the transmitted signals are divided for sensing.

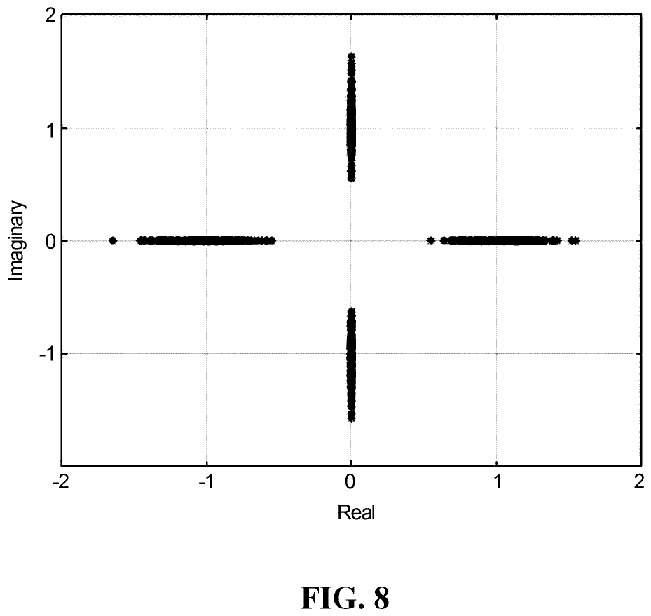

The impact of floor clipping on a single carrier signal is described with reference to FIGS. 8-12.

FIG. 8 shows a constellation diagram of a simulation of a single carrier orthogonal quadrature phase-shift keying (SC-OQPSK) signal after floor clipping. SC-OQPSK is another example of a single carrier signal to which aspects of the present disclosure may be applied. The constellation diagram is shown as a two-dimensional scatter diagram in the real-imaginary plane at symbol sampling instants. The constellation diagram is indicative of the distortion of the signal caused by floor clipping. If floor clipping caused no distortion, then only four individual points would be shown in the constellation diagram. Instead, FIG. 8 shows some spreading along the axes such that there are multiple distinct points shown along the imaginary and real axes of the constellation diagram. This indicates that some distortion of the SC-OQPSK signal has occurred. However, as shown in FIG. 8, none of the real or imaginary points has crossed its respective boundary as a result of the floor clipping, which means that the impact of floor clipping on the SC-OQPSK signal is very limited. In practice, this means that the distortion caused by floor clipping is likely to be negligible compared to other effects such as a noise. In other words, the performance of e.g. a communication link that uses floor clipped SC-OQPSK is more likely to be limited by noise rather than by any distortion caused by floor clipping. This may be particularly important in the context of communication, in which signal distortion can cause a loss of performance.

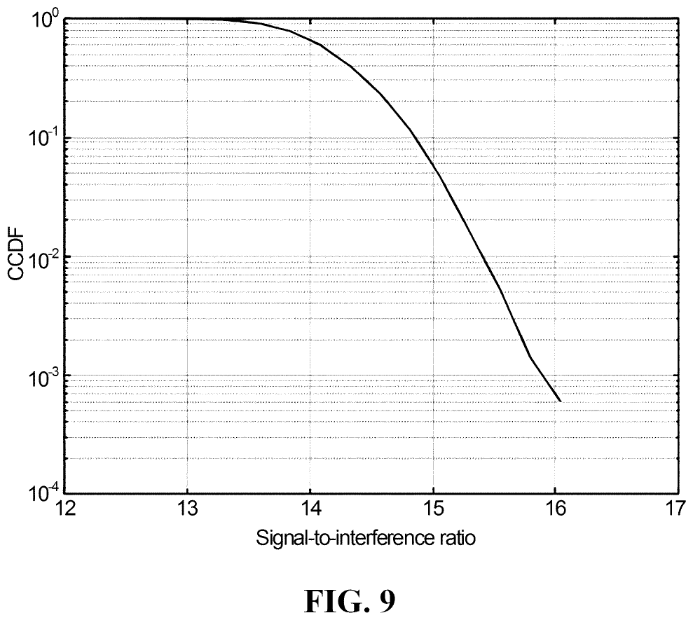

It will be appreciated that the distortion shown in FIG. 8 may be data dependent. That is, different SC-OQPSK signals (or different single carrier signals) may exhibit different constellation diagrams depending on the data the respective signal is carrying. A more comprehensive view of the impact of floor clipping is shown in FIG. 9.

FIG. 9 shows a complementary cumulative distribution function (CCDF) of the per-symbol base signal-to-interference ratio (SIR) for the simulated SC-OQPSK signal after floor clipping. FIG. 9 shows that the SIR range is well above 12 dB, which is much higher than the typical operating range of QPSK modulation which is around ˜6 dB. This demonstrates that any distortion of SC-OQPSK signals caused by floor clipping as described herein is expected to be negligible compared to other effects such as noise.

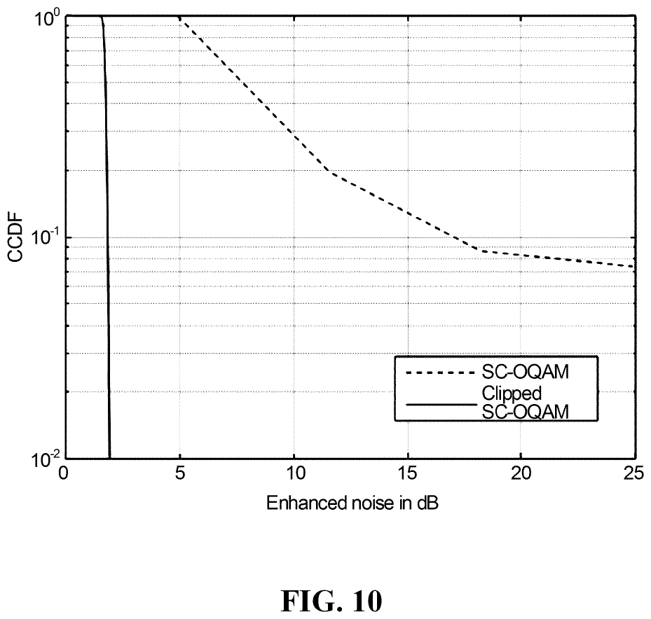

FIG. 10 shows a CCDF of the noise enhancement of a simulated SC-OQAM signal with (solid line) and without (dashed line) floor clipping. In the context of FIG. 10, noise enhancement indicates the increase in noise caused by dividing, in the frequency domain, a reflection of the SC-OQAM signal that is received at a receiver by the SC-OQAM signal that was originally transmitted. This simulation used zero forcing (ZF), rather than minimum mean square error (MMSE) that is usually used in radar systems. However, the evaluation of MMSE can be noise power dependent, so ZF is used here for simplicity. In addition, MMSE normally results a smaller noise enhancement, so FIG. 10 is illustrative of the potential noise enhancement that could occur.

As shown by the dashed line in FIG. 10, the noise enhancement effect is uncontrollable when the reflected signal (e.g. the echo signal) is divided by the transmitted SC-OQAM signal (e.g. the corresponding SC-OQAM signal) in the frequency domain without any floor clipping. In contrast, floor clipping the signal before transmission (the solid line) results in noise enhancement being well controlled at (e.g. remains at or below) 2 dB. This is important for sensing, in which improvements in controlling the noise enhancement can improve sensing accuracy. In some examples, a root-raised cosine (RRC) window may be applied by the transmitter and/or the receiver. This may be referred to as applying an RRC matched filter at the receiver. Together, the two RRC windows form an RC window, which can further improve the dynamic range of the ambiguity function. Compared to RC windowed OFDM, which has a ˜1.75 dB loss in SNR, and the matched filter gain (e.g. applying RRC at the radar) in SC-OQAM, floor clipped SC-OQAM can have an SNR advantage in sensing.

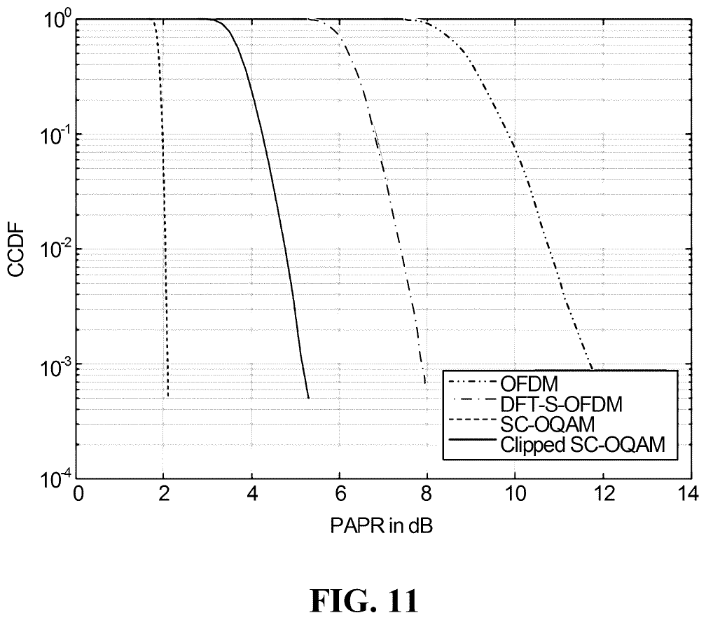

FIG. 11 shows the CCDF of the PAPR for simulations of an OFDM signal (the dot-dot-dashed line that is the furthest to the right), a DFT-S-OFDM signal (the dot-dashed line second from the right), a SC-OQAM signal (the dashed line furthest to the left), and a floor clipped SC-OQAM signal (the solid line that is second to the left).

FIG. 11 shows that SC-OQAM without floor clipping has the lowest PAPR, whilst OFDM and DFT-S-OFDM have the highest and second highest PAPR respectively. Floor clipping causes the PAPR of an SC-OQAM waveform to increase. However, the PAPR of the floor clipped SC-OQAM signal is still much lower than OFDM. This illustrates that a floor clipped single carrier signal can achieve a lower PAPR than using OFDM, which means that floor clipping enables reducing noise enhancement whilst minimising PAPR.

FIG. 11 also shows that the floor clipped SC-OQAM has a lower PAPR than DFT-S-OFDM. This illustrates that, although floor clipping may be used for a variety of single carrier waveforms such as DFT-S-OFDM, SC-OQAM and SC-OQPRSK to reduce noise enhancement, floor clipped SC-OQAM may be particularly advantageous because it has a lower PAPR than other single carrier waveforms.

In summary, a single carrier signal may be floor clipped in the frequency domain to allow for improving the ambiguity function of the single carrier signal whilst reducing noise enhancement. In addition, as shown above, floor clipping has minimal impact on signal distortion. This allows for the use of single carrier signals in a variety of applications, such as integrated sensing and communication, which means those applications can benefit from the lower PAPR of single carrier signals. SC-OQAM and DFT-S-OFDM may be particularly advantageous due their high data throughput. SC-OQAM, in particular, may be advantageous due its high data throughput and particularly low PAPR.

In the examples described above, the single carrier signal is floor clipped by applying a minimum value to the power spectrum of the single carrier signal (e.g. resulting in the hard cut off shown in FIG. 7). In general, some or all of the advantages described herein may be obtained by increasing the amplitude of one or more samples of the frequency domain representation of the single carrier signal such that the power of the respective samples is larger than a minimum value. Increasing the amplitude of at least some of the samples of the single carrier signal in the frequency domain can reduce the number of small amplitude samples and thereby reduce any noise enhancement that may otherwise have occurred when processing a reflection of the single carrier signal.

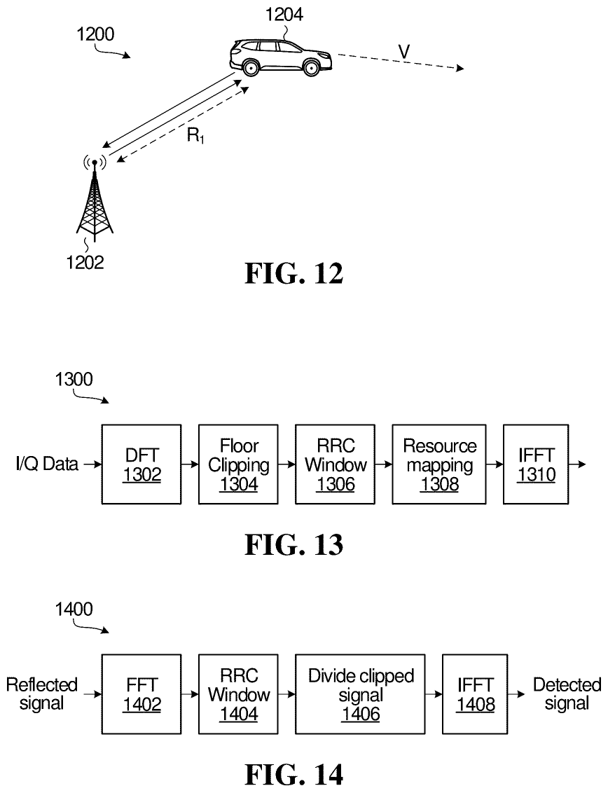

Although floor clipping of a single carrier signal in the frequency domain can provide benefits for a variety of applications, it may be particularly advantageous for sensing and, in particular, integrated sensing and communication. Examples of applying floor clipping of a single carrier signal in the frequency domain for sensing applications are described with reference to FIGS. 12-16.

FIG. 12 shows a system 1200 according to an embodiment of the disclosure. The system 1200 comprises a first sensing node 1202 and an object 1204.

In this embodiment, the first sensing node 1202 includes a processor, a transmitter, a receiver, an antenna and a memory. Alternatively, the first sensing node 1202 may comprise a transceiver instead of the transmitter and the receiver. The processor implements various operations of the first sensing node 1202, including the operations described below as well as other operations such as such as signal coding, data processing, power control or any other functionality. The processor includes any suitable processing or computing device configured to perform the one or more operations. The processor could, for example, include a microprocessor, microcontroller, digital signal processor, field programmable gate array or application specific integrated circuit.

In FIG. 12, the first sensing node 1202 is illustrated as a network node. The first sensing node 1202 may comprise a base station or a TRP, such as any of the TRPs 170a-170b described above, for example. In other embodiments, the first sensing node 1202 may comprise an electronic device, such as any of the electronic devices 110 described above. In particular examples, the first sensing node 1202 may comprise a vehicle, such as a vehicle in a V2X or vehicle-to-vehicle (V2V) network. In general, the first sensing node 1202 may be any apparatus (e.g. any device) capable of transmitting and receiving sensing signals.

The object 1204 may be any object 1204 detectable with sensing (e.g. detectable with radio signal-based sensing). The object 1204 may be referred to as a target. In FIG. 12, the object 1204 is illustrated as a car. In other embodiments, the object 1204 may comprise another type of vehicle (e.g. a bus, train etc.) or another type of object. The object 1204 may, for example, comprise a communication device, such as a network node (e.g. a base station or TRP, such as any of the TRPs 170a-170b described above) or an electronic device (e.g. any of the electronic devices 110 described above).

The first sensing node 1202 is separated from the object 1204 by a distance R₁. The object is moving (e.g. travelling) with a speed v.

The first sensing node 1202 determines a sensing estimate for the object 1204 by transmitting a signal towards the object 1204, receiving a reflected signal comprising a reflection of the signal from the object 1204 and processing the reflected signal to determine the sensing estimate. The signal may be referred to as the sensing signal. The sensing estimate may include, for example, one or more of: the distance R₁ between the first sensing node 1202 and the object 1204, a direction to the object 1204 from the first sensing node 1202 and a movement (e.g. the speed v, a direction of movement and/or an acceleration) of the object 1204 (e.g. relative to any movement of the first sensing node 1202).

FIG. 13 shows a block diagram corresponding to a flowchart of a method 1300 performed by the first sensing node 1202 to process the single carrier signal to obtain a signal for transmission according to an embodiment of the disclosure.

The method 1300 may begin with the first sensing node 1202 obtaining the single carrier signal. The single carrier signal comprises real (I) and imaginary components (Q) and may thus be referred to as I/Q data. The single carrier signal may be obtained from a baseband unit of the first sensing node 1202, for example. As such, in some examples, the single carrier signal may be referred to as a baseband signal.

In some examples, the single carrier signal may include one or more redundant bits (e.g. in the form of an error correcting code). The one or more redundant bits (or redundant data) may have been generated using a forward error correction (FEC) code. Any suitable FEC may have been used (e.g. by the first sensing node) to generate the one or more redundant bits such as a turbo code, a low density parity check code, a polar code, a Hamming code etc.

The single carrier signal may be any single carrier signal that is suitable for sensing such as SC-OQAM, DFT-S-OFDM, SC-OQPSK etc. The single carrier signal may be referred to as a sensing signal. The single carrier signal might or might not also be a communication signal. For example, the sensing signal might or might not carry a control signal and/or data to be received e.g. by the object 1204. The sensing signal may be a radio signal.

In step 1302, the first sensing node 1202 performs a discrete Fourier transform (DFT) on the single carrier signal to obtain a representation of the single carrier signal in the frequency domain, which may be referred to as a frequency domain single carrier signal. The first sensing node 1202 may, for example, perform a fast Fourier transform (FFT) on the single carrier signal. The frequency domain representation of the single carrier signal includes one or more samples of the single carrier signal at respective subcarriers. Thus, for example, the frequency domain representation of the single carrier signal may, for each respective subcarrier (e.g. at a particular frequency), comprise a respective sample of the single carrier signal. Each sample may be expressed as:

$${x}_{i} = {A}_{i} {e}^{j {θ}_{i}} , \qquad ( 2 )$$

in which Aᵢ and θᵢ are the amplitude and phase of a sample identified by index (or identifier) i.

In step 1304, the first sensing node 1202 sets, for a sample in the one or more samples, an amplitude of the respective sample to a larger amplitude such that a power of the respective sample is no less than a minimum value. By setting the amplitude of at least one the samples in this way, the first sensing node 1202 applies a floor to, or floor clips, at least one of the samples. Setting the amplitude of a respective sample to a larger amplitude may also be referred to as increasing the amplitude of the sample.

In some examples, step 1304 may be performed in accordance with the floor clipping described above (e.g. the floor clipping described above in respect of FIG. 7).

In some examples, the first sensing node 1202 may, for each sample having a power less than the minimum value, set the amplitude of the respective sample to a larger amplitude such that a power of the respective sample is no less than a minimum value. This may be referred to as applying a floor to or floor clipping the frequency domain representation of the single carrier signal.

In some examples, the first sensing node 1202 may apply the same floor to each of the samples. Thus, the first sensing node 1202 may, for any sample having a power below a minimum value, set its amplitude set to a same particular value. For example, the first sensing node 1202 may set the amplitude of each sample having an amplitude below the a threshold value (e.g. the square root of the minimum value for the power) to the threshold value. The first sensing node 1202 may, for example, set the amplitude of each sample according to Equation (1), for example. This may be referred to as hard clipping or hard floor clipping. This may be particularly advantageous as it may involve less processing than other clipping methods (e.g. compared to soft clipping methods), thereby saving processing resources.

The minimum value may be any suitable value. The minimum value may be based on the average power (e.g. mean or median) of the single carrier signal. The minimum value may be expressed as ρ. ρ may, for example, be a fixed value below the average power of the single carrier signal. For example, ρ may be 3 dB below the average power. In another example, ρ may be 6 dB below the average power. The difference between ρ and the average power may be in the range 3 dB-6 dB. In some examples, ρ may be based on the average and standard deviation of the power of the single carrier signal. For example, ρ may be NG below the average power, in which N is an integer (e.g. N=1) and σ is the standard deviation in the power of the single carrier signal.

In the above examples, the amplitude of a particular sample is set such that the power of a sample is no less than (e.g. greater than, or greater than or equal to) a minimum value. This may alternatively be described as setting the amplitude of the respective sample such that the amplitude is no less than (e.g. greater than, or greater than or equal to) a minimum amplitude. As such, the floor applied to a sample (e.g. to the entire signal) may be expressed in terms of the amplitude or the power of the sample.

The choice of minimum value may be a trade-off between reducing noise enhancement to improve sensing performance whilst minimising signal distortion to maintain communication performance. If the minimum value is too high (e.g. the floor applied to the single carrier signal is too high), there is a risk of increased distortion, which may affect communication performance. If the minimum value is too low (e.g. the floor applied to the single carrier signal is too low), then noise enhancement might not be sufficiently reduced, which may affect sensing performance. As such, in some embodiments, the minimum value and/or the value to which an amplitude of the sample is set (which may be the same) may be determined based on a relative importance of communication and sensing.

In some examples, the minimum value and/or the value to which an amplitude of the sample is set (which may be the same or different) may be based on the modulation scheme of the single carrier signal. The minimum value and/or the value to which an amplitude of the sample is set may be lower for a higher order modulation scheme, as it may be more important to minimise distortion for higher order modulation schemes.

In some examples, the minimum value and/or the value to which an amplitude of the sample is set (which may be the same) may be based on the type of single carrier signal. As discussed above, different single carrier signals have different PAPR. For example, DFT-S-OFDM has a higher PAPR than SC-OQAM. Therefore, the minimum value and/or the value to which an amplitude of the sample is set may be smaller for a single carrier signal that has a higher PAPR compared to a single carrier signal that has a lower PAPR. For example, a smaller minimum value and/or value to which an amplitude of the sample is set may be used for DFT-S-OFDM (e.g. ρ may be 6 dB below the average power of the single carrier signal for DFT-S-OFDM) compared to SC-OQAM (e.g. ρ may be 3 dB below the average power of the single carrier signal for SC-OQAM).

The smaller the minimum value and/or the value to which an amplitude of the sample is set, the smaller the increase in the PAPR caused by clipping. Therefore, using a smaller minimum value and/or value to which an amplitude of the sample is set (which may be the same) for single carrier signals having a high PAPR can keep the PAPR low whilst still allowing noise enhancement to be reduced.

In step 1306, the first sensing node 1202 applies an RRC window to the frequency domain single carrier signal (e.g. after the frequency domain single carrier signal has been altered due to step 1306). The first sensing node 1202 may thus multiply the frequency domain single carrier signal by the RRC window.

In step 1308, the first sensing node 1202 maps the frequency domain representation of the (RRC windowed) single carrier signal to one or more network resources (e.g. one or more time-frequency resources) for transmission. The first sensing node 1202 may thus assign the signal to one or more allocated subcarriers in the frequency domain.

In step 1310, the first sensing node 1202 performs an inverse fast Fourier transform (IFFT) on the frequency domain representation of the RRC windowed single carrier signal. In general, the first sensing node 1202 may perform an inverse Fourier transform on the frequency domain representation of the single carrier signal using any suitable method (e.g. might use an IFFT or another approach). The first sensing node 1202 may thus covert the frequency domain representation of the single carrier signal (e.g. the frequency-domain signal) to a time domain representation of the single carrier signal (e.g. the time-domain signal). In some examples, step 1306 may be omitted and the first sensing node 1202 may perform the IFFT on the frequency domain representation of the single carrier signal.

The first sensing node 1202 may thus, in the method 1300, process the single carrier signal to obtain a signal for transmission.

The first sensing node 1202 transmits the single carrier signal (e.g. obtained from step 1310) using the one or more network resources. The first sensing node 1202 may transmit the signal using an antenna at the first sensing node 1202, for example.

The first sensing node 1202 may transmit the signal towards the object 1204. For example, the first sensing node 1202 may transmit the signal using one or more beams, in which the one or more beams are based (e.g. determined or selected based on) an estimated (e.g. predicted) location of the object 1204. In another example, the first sensing node 1202 may broadcast the signal.

The transmitted signal reflects from the object 1204 such that a reflection of the signal is received at the first sensing node 1202. The first sensing node 1202 may thus receive an echo of the transmitted signal, in which the echo is reflected from the object 1204.

The first sensing node 1202 receives the reflected signal (e.g. at an antenna of the first sensing node 1400).

FIG. 14 shows a block diagram corresponding to a flowchart of a method 1400 performed by the first sensing node 1202 for processing the reflected signal obtain a detected signal (e.g. such that a sensing estimate for the object 1204 can be obtained from the detected signal).

In step 1402, the first sensing node 1202 performs a fast Fourier transform (FFT) on the reflected signal to obtain a representation of the reflected signal in the frequency domain. In general, the first sensing node 1202 may perform a discrete Fourier transform on the reflected signal using any suitable method (e.g. might use an FFT or another approach). The first sensing node 1202 may thus covert the time domain representation of the reflected signal (e.g. the frequency-domain signal) to a frequency domain representation of the reflected signal (e.g. the time-domain signal).

In step 1404, the first sensing node 1202 applies an RRC window to the frequency domain representation of the reflected signal. Step 1404 may be performed in a similar manner to step 1306, except that it is performed on the reflected signal, rather than the single carrier signal.

In step 1406, the first sensing node 1202 divides the frequency domain representation of the RRC windowed reflected signal by the frequency domain representation of the single carrier signal. That is, the first sensing node 1202 divides the signal obtained in step 1404 by the signal obtained from step 1306. In some examples, step 1404 may be omitted, and the first sensing node 1202 may divide the frequency domain representation of the reflected signal (e.g. obtained from step 1402) by the frequency domain representation of the single carrier signal. As a result of the floor clipping performed in step 1304, the frequency domain representation of the single carrier signal (with or without RRC windowing) has fewer samples with small amplitudes (e.g. has fewer samples with amplitudes close to zero), which means that the risk of noise enhancement occurring in step 1406 is reduced.

In step 1408, the first sensing node 1202 performs an IFFT on the divided signal obtained from step 1406 to obtain the detected signal. In general, the first sensing node 1202 may perform an inverse Fourier transform on the divided signal using any suitable method (e.g. might use an IFFT or another approach). The first sensing node 1202 may thus covert the frequency domain representation of the divided reflected signal (e.g. the frequency-domain signal) to a time domain representation of the divided reflected signal (e.g. the time-domain signal).

The first sensing node 1202 may determine the sensing estimate for the object 1204 using the signal obtained from step 1408 (e.g. using the time-domain signal). The sensing estimate may indicate the presence of the object 1204. The sensing estimate may comprise an estimate of pose information for the object 1204. The sensing estimate may comprise an estimate of one or more of: the distance R₁, a direction of the object 1204 and a movement of the object 1204 (e.g. the speed v). The direction of the object 1204 may be a bearing or angle from the first sensing node 1202 to the object 1204.

The first sensing node 1202 may thus use the methods 1300 and 1400 to detect the object 1204 and/or determine a distance, direction and/or movement of the object 1204. This approach may be referred to as monostatic sensing, since the same device (the first sensing node 1202) transmits the single carrier signal and receives the reflection of the single carrier signal that is used to determine the sensing estimate. It will be appreciated that in other embodiments, further processing may be performed by the first sensing node 1202 in order to generate the signal for transmission and/or process the reflected signal. For example, the first sensing node 1202 may perform forward error correction (FEC) coding on the single carrier signal before it is transmitted.

In yet further embodiments, one or more of the steps described above (e.g. one or more of the steps of the methods 1300 and/or 1400) may be performed by another node. For example, the time domain signal obtained from step 1408 may be transmitted to another node for the other node to determine the sensing estimate.

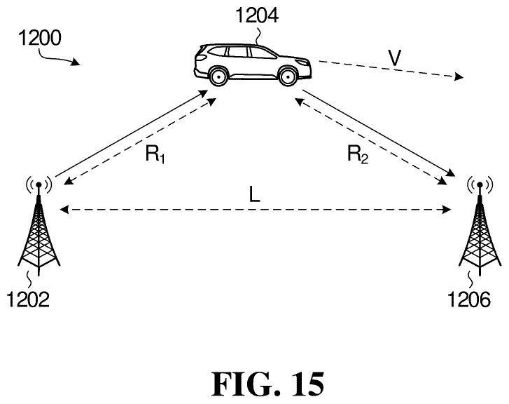

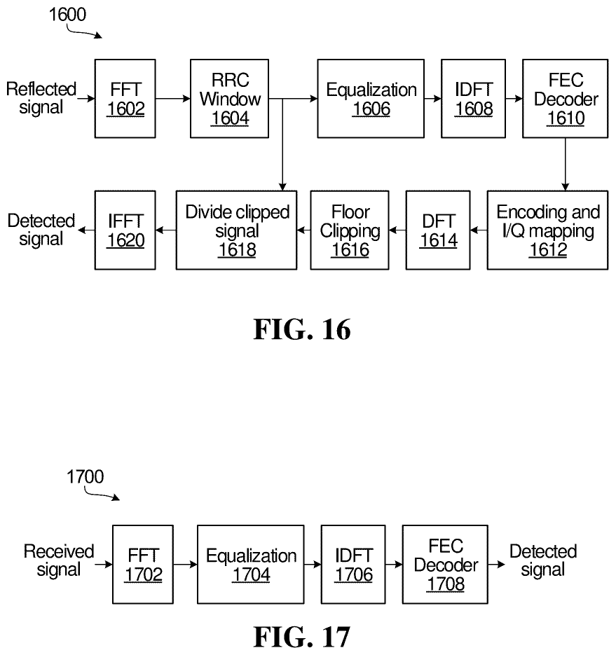

In some embodiments, the reflected signal may be received by another device (e.g. by a device other than the first sensing node). This may be referred to as bistatic sensing. An example of bistatic sensing is described with reference to FIGS. 15 and 16.

FIG. 15 shows an alternative embodiment of the system 1200. In this embodiment, the system 1200 comprises the first sensing node 1202 and the object 1204 described above. In addition, the system 1200 further comprises a second sensing node 1206. The second sensing node 1206 is for receiving the reflection of a sensing signal transmitted by the first sensing node 1202. The object 1204 is separated from the receiver device 1206 by a distance R₂. The first sensing node 1202 and the second sensing node 1206 are separated by a distance L.

The second sensing node 1206 includes a processor, a receiver, an antenna and a memory. The second sensing node 1206 may also comprise a transmitter, or a transceiver (e.g. to replace the transmitter and the receiver). The processor implements various operations of the second sensing node 1206, including the operations described below as well as other operations such as such as data processing, power control or any other functionality. The processor includes any suitable processing or computing device configured to perform the one or more operations. The processor could, for example, include a microprocessor, microcontroller, digital signal processor, field programmable gate array or application specific integrated circuit.

In FIG. 15, the second sensing node 1206 is illustrated as a network node. The second sensing node 1206 may comprise a base station or a TRP, such as any of the TRPs 170a-170b described above, for example. In other embodiments, the second sensing node 1206 may comprise an electronic device, such as any of the electronic devices 110 described above. In particular examples, the second sensing node 1206 may comprise a vehicle, such as a vehicle in a V2X or vehicle-to-vehicle (V2V) network. In general, the second sensing node 1206 may be any apparatus (e.g. device) capable of receiving a reflection of the single carrier signal from the object 1204.

In this embodiment, the first sensing node 1202 processes and transmits a single carrier signal as described above in respect of FIGS. 12 and 13 above. The first sensing node 202 may primarily act as a transmitter device (e.g. because it transmits a sensing signal). As such, the first sensing node 1206 may or might not include a receiver.

The transmitted signal is reflected by the object 1204 such that the reflected signal is received by the second sensing node 1206.

FIG. 16 shows a block diagram corresponding to a flowchart of a method 1600 performed by the second sensing node 1206 for processing the reflected signal to obtain a detected signal (e.g. such that a sensing estimate for the object 1204 can be obtained from the detected signal).

In steps 1602 and 1604, the second sensing node 1206 performs an FFT and applies an RRC window to the reflected signal. Steps 1602 and 1604 may be performed in the same manner as 1402 and 1404 described above.

One difference between bistatic sensing and the monostatic sensing described above is that the second sensing node 1206 may not know what signal was originally transmitted by the first sensing node 1202. Thus, the second sensing node 1206 may, in steps 1606-1616 process the reflected signal to obtain an estimate of the signal that was transmitted by the first sensing node 1202.

In step 1606, the second sensing node 1206 equalizes the frequency domain representation of the reflected signal obtained in step 1604. That is, the second sensing node 1206 may divide the channel from the received signal. In some examples, a minimum mean squared error (MMSE) equalizer may be used. This may be particularly appropriate in examples in which the signal comprises a DFT-S-OFDM signal or an SC-OQAM signal.

In step 1608, the second sensing node 1206 performs an inverse discrete Fourier transform (IDFT) on the equalized frequency domain representation of the reflected signal. The second sensing node 1206 may, for example, perform an IFFT on the signal obtained from step 1606. The second sensing node 1206 may thus convert the frequency domain representation of the equalized RRC windowed reflected signal to the time domain.

In step 1610, the second sensing node 1610 FEC decodes the signal obtained from step 1608. The reflected signal may comprise one or more redundant bits (e.g. redundant data), in the form of an error correcting code, which the second sensing node 1206 may use to detect errors in the reflected signal. Any suitable FEC may have been used (e.g. by the first sensing node) to generate the one or more redundant bits such as a turbo code, a low density parity check code, a polar code, a Hamming code etc. The second sensing node 1610 may use any suitable decoding technique to decode the signal in step 1610.

In step 1612, the second sensing node 1610 modulates the decoded signal. This may be referred to as encoding and I/Q mapping. The second sensing node 1610 may perform quadrature amplitude modulation (QAM) for example. That is, the second sensing node 1610 may, in step 1612, map binary bits to QAM symbols.

In step 1614, the second sensing node 1610 performs a DFT on the signal obtained from step 1612. Step 1614 may be performed in accordance with step 1302 described above, except that the DFT is performed on the reflected signal (as obtained from step 1612), rather than the single carrier signal. The second sensing node 1610 thus obtains a frequency domain representation of the reflected signal, in which the frequency domain representation of the reflected signal includes one or more samples of the reflected signal at respective subcarriers.

In step 1616, the second sensing node 1206 sets, for a sample in the one or more samples, an amplitude of the respective sample to a larger amplitude such that a power of the respective sample is no less than (e.g. greater than, or greater than or equal to) a minimum value. Step 1616 may be performed in accordance with step 1304 described above. The second sensing node 1206 may receive an indication of the minimum value (e.g. from the first sensing node 1202 or another device). Alternatively, the second sensing node 1206 may be preconfigured with the minimum value.

The second sensing node 1206 thus, in steps 1606-1616, determines an estimate of the frequency domain representation of the signal that was transmitted by the first sensing node 1202. This eliminates the need for the first sensing node 1202 to transmit the single carrier signal directly to the second sensing node 1206 (e.g. in addition to transmitting the single carrier signal towards the object 1204). In addition, by setting the amplitude of the one or more samples to no less than the minimum value, the second sensing node 1206 simulates the floor clipping performed by the first sensing node 1202, which reduces the risk that floor clipping will affect sensing performance.

In step 1618, the second sensing node 1206 divides the RRC windowed frequency domain representation of the reflected signal obtained from step 1604 by the estimate of the frequency domain representation of the signal that was transmitted by the first sensing node 1202 (as obtained in steps 1606-1616). Step 1618 may be performed in accordance with step 1406 described above, using the estimate of the frequency domain signal that was transmitted, rather than the frequency domain signal itself.

In other embodiments, steps 1606-1616 may be omitted and the second sensing node 1206 may obtain the frequency domain representation of the signal that was transmitted by the first sensing node 1202 (e.g. rather than an estimate). The second sensing node 1206 may, for example, receive, from the first sensing node 1202, the signal that was transmitted by the first sensing node 1202 towards the object 1204 and perform a Fourier transform on the received signal to obtain the frequency domain representation of the signal that was transmitted by the first sensing node 1202. As such, step 1618 may be performed using frequency domain signal that was transmitted, rather than the estimate of the frequency domain signal.

In step 1620, the second sensing node 1206 performs an IFFT on the divided signal obtained from step 1618. Step 1620 may be performed in accordance with step 1408 described above. The first sensing node 1206 may thus convert the frequency domain representation of the divided reflected signal (e.g. the frequency-domain signal) to a time domain representation of the divided reflected signal (e.g. the time-domain signal).

The second sensing node 1206 may determine a sensing estimate for the object 1204 using the signal obtained from step 1620 (e.g. using the time-domain signal). The sensing estimate may be determined as described above in respect of the first sensing node 1202 and the method 1400.

In the embodiments described in respect of FIGS. 12-16, the first sensing node 1202 transmits a signal obtained by applying a floor to at least one of the samples in a frequency domain representation of a single carrier signal. The transmitted signal is reflected from the object 1204 such that the reflected signal is received by the first sensing node 1202 (e.g. in the methods described in respect of FIGS. 12-14) or the second sensing node 1206 (e.g. in the methods described in respect of FIGS. 15-16).

In some embodiments, the object 1204 may receive the signal transmitted by the first sensing node 1202. That is, the signal transmitted by the first sensing node 1202 may be used for communication with the object 1204 and/or sensing of the object 1204. Before transmission, the signal may be modulated by the first sensing node 1202 to carry data and/or a control signal such as a reference signal or synchronization signal. Thus, the signal transmitted by the first sensing node 1202 may be a communication signal. The signal may be transmitted using a PDSCH or a PDCCH, or other types of channels to transmit different types of reference/measurement signals or synchronization signals, for example. In particular examples, the signal transmitted by the first sensing node 1202 may be a sensing signal and a communication signal. This may be referred to as an integrated sensing and communication (ISAC) signal.

In these embodiments, the object 1204 may be any apparatus (e.g. device) capable of receiving the single carrier signal from the first sensing node 1202. The object 1204 may be communication device, such as a network node (e.g. a base station or TRP, such as any of the TRPs 170a-170b described above) or an electronic device (e.g. any of the electronic devices 110 described above). The object 1204 may include a processor, a receiver, an antenna and a memory. The object 1204 may also comprise a transmitter, or a transceiver (e.g. to replace the transmitter and the receiver). The processor implements various operations of the object 1204, including the operations described below as well as other operations such as such as data processing, power control or any other functionality. The processor includes any suitable processing or computing device configured to perform the one or more operations. The processor could, for example, include a microprocessor, microcontroller, digital signal processor, field programmable gate array or application specific integrated circuit.

An example method 1700 performed by the object 1204 on the signal received from the first sensing node 1202 is described with respect to FIG. 17, which shows a block diagram corresponding to the example method 1700.

In step 1702, the object 1204 performs an FFT on the received signal. Step 1702 may be performed in accordance with steps 1402 and 1602 described above, except that the FFT is performed on the single carrier signal transmitted by the first sensing node 1202, rather than the reflection of the single carrier signal transmitted by the first sensing node 1202.

In step 1704, the object 1204 equalizes the frequency domain representation of the received single carrier signal obtained in step 1702. That is, the object 1204 may divide the channel (e.g. the channel between the first sensing node 1202 and the object 1204) from the received signal. In some examples, an MMSE equalizer may be used. This may be particularly appropriate in examples in which the signal comprises a DFT-S-OFDM signal or an SC-OQAM signal.

In step 1706, the object 1204 performs an inverse discrete Fourier transform (IDFT) on the equalized frequency domain representation of the received single carrier signal. The object 1204 may, for example, perform an IFFT on the signal obtained from step 1704. The object 1204 may thus convert the frequency domain representation of the equalized single carrier signal to the time domain.

In step 1708, the object 1204 FEC decodes the signal obtained from step 1706. The receive single carrier signal may comprise one or more redundant bits (e.g. redundant data), in the form of an error correcting code, which the object 1204 may use to detect errors in the reflected signal. Any suitable FEC may have been used (e.g. by the first sensing node) to generate the one or more redundant bits such as a turbo code, a low density parity check code, a polar code, a Hamming code etc. The object 1204 may use any suitable decoding technique to decode the signal in step 1708.

The object 1204 obtains, from step 1708, a detected signal based on the signal received from the first sensing node 1202. The detected signal may comprise, for example, data and/or a control signal transmitted by the first sensing node 1202. The object 1204 may thus process the received signal using the method 1700 to obtain the data and/or control signal. This allows the same signal to be used for communication with the object 1204 and sensing the object 1204, which can save network resources.

The object 1204 may use the detected signal for one or more purposes. The object 1204 may, for example, use the detected signal for measuring, updating and/or monitoring Channel State Information (CSI). The object 1204 may, for example, measure one or more reference signals included in the detected signal to measure and/or monitor CSI. In some examples, the object 1204 may use the detected signal for beam measurement and/or beam tracking. For example, the first sensing node 1202 may transmit the single carrier signal to the object 1204 using a plurality of beams. The object 1204 may measure a received signal received power (RSRP) of each of the beams received by the object 1204 and report the RSRP of at least one of the beams to the first sensing node 1202. The first sensing node 1202 may use this information to select a beam for communication with the object 1204. This may be particularly appropriate in examples in which the single carrier signal carries a CSI reference signal and/or synchronization signal block (SSB). It will be appreciated that the purposes described above are provided byway of example only. In general, the object 1204 may use the detected signal for one or more of the purposes described herein and/or any other suitable purpose.

Aspects of the present disclosure thus provide methods of processing a single carrier signal to obtain a signal for transmission (e.g. the method 1300), processing the received signal (e.g. the method 1700) and processing a reflection of the transmitted signal from an object (e.g. the methods 1400 and 1600) to allow a sensing estimate for the object to be determined. It will be appreciated that these embodiments are merely examples of how aspects of the present disclosure may be implemented for sensing. In other embodiments, some of the steps of the methods 1300, 1400, 1600 and/or 1700 may be omitted, modified and/or performed in a different order.

In the embodiments described above in respect of FIGS. 12-16, the single carrier signal is only used only for sensing of the object 1204 and/or communication with the object 1204. In some embodiments, the single carrier signal may also be used for communication with the object 1204 and/or the second sensing node 1206. In general, the single carrier signal may be used for sensing of and/or communication with one or more objects (e.g. the object 1204 and one or more further objects).

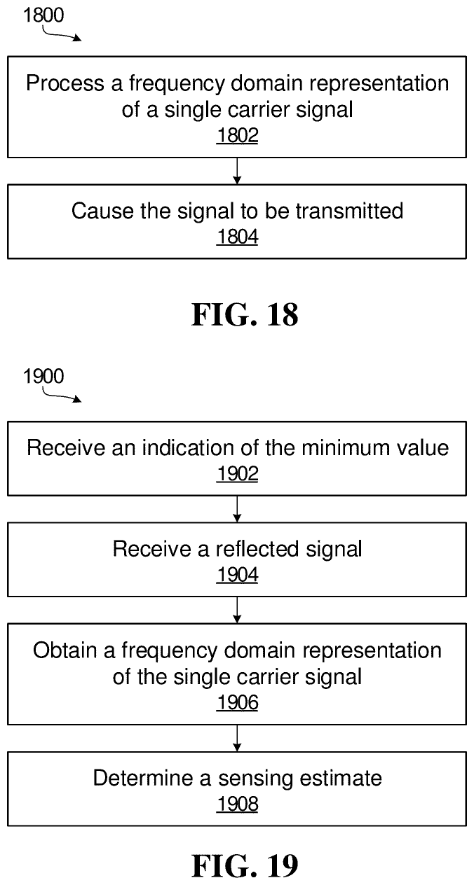

FIG. 18 shows a flowchart of a method 1800 according to embodiments of the disclosure. The method 1800 may be performed by a sensing node such as the first sensing node 1202, for example. In some embodiments, the method 1800 may be performed by a processor, such as a processor of the first sensing node 1202. In general, the method 1800 may be performed by any suitable apparatus, or a processor of the apparatus. In some embodiments, the method 1800 may be distributed across (e.g. performed by) more than one apparatus.

The method 1800 involves, in step 1802, generating a single carrier signal for transmission. Generating the single carrier signal may, for example, involve processing a frequency domain representation of a single carrier signal to obtain a signal for transmission. The single carrier signal may be a single carrier radio signal. The single carrier signal may comprise any of the single carrier signals described above. The single carrier signal may comprise, for example, a DFT-S-OFDM signal, a SC-OQAM signal or a SC-OQPSK signal.

The single carrier signal may comprise a sensing signal (e.g. as described above in respect of FIGS. 12-16). Additionally or alternatively, the single carrier signal may comprise a communication signal. In particular examples, the single carrier signal may comprise an integrated sensing and communication (ISAC) signal. Although aspects of the present disclosure may be particularly advantageous for sensing and for ISAC in particular, it will be appreciated that the present disclosure is not limited as such.

The frequency domain representation of the single carrier signal includes one or more samples of the single carrier signal at respective subcarriers. The method 1800 may also involve obtaining the frequency domain representation of the single carrier signal. The method 1800 may involve receiving the frequency domain representation of the single carrier signal (e.g. from another device or apparatus). Alternatively, the method 1800 may involve performing a Fourier transform on the single carrier signal to obtain the frequency domain representation of the single carrier signal (e.g. in accordance with step 1302 described above).

Processing the frequency domain representation of the single carrier signal involves, for a sample in the one or more samples, setting an amplitude of the respective sample to a larger amplitude such that a power of the respective sample is no less than (e.g. is greater than, or greater than or equal to) a minimum value. The minimum value may be determined as described above (e.g. based on an average power of the single carrier signal). Setting the amplitude of a respective sample to a larger amplitude may also be referred to as increasing the amplitude of the sample.

In some examples, step 1802 may involve, for each sample in the one or more samples, setting the amplitude of the respective sample to a larger amplitude such that a power of the respective sample is no less than a minimum value. Each sample may be set to a same amplitude (e.g. to a square root of the minimum value) or a respective (e.g. different) amplitude. In some examples, step 1802 may involve setting the amplitude of a respective sample according to:

$${x}_{i} = \sqrt{ρ} {e}^{j {θ}_{i}} ,$$

in which θᵢ is a phase of the respective sample xᵢ and ρ is the minimum value.

Step 1802 may be performed in accordance with floor clipping described above. In some examples, step 1802 may be performed in accordance with step 1304 described above.

In some examples, processing the frequency domain representation of the single carrier signal may involve applying an RRC window to the frequency domain representation of the single carrier signal. This may be performed in accordance with step 1306 described above, for example.

The method 1800 also involves, in step 1804, causing the signal to be transmitted. Causing the signal to be transmitted may involve outputting the signal from a processor or an apparatus. Step 1804 may further involve transmitting the signal. For example, step 1804 may involve an apparatus transmitting the signal (e.g. using an antenna of the apparatus). Step 1804 may involve providing the signal to an antenna for transmission. For example, step 1804 may involve a processor of an apparatus providing the signal to an antenna of the apparatus for transmission.

The signal may be caused to be transmitted towards an object or target to be sensed (e.g. using one or more beams selected based on a predicted or estimated position of the object), such as the object 1204. The signal may be caused to be broadcasted. In some examples, the method 1800 may involve causing the signal to be transmitted towards an object to be sensed and towards a receiving apparatus (e.g. the second sensing node 1206) such that the receiving apparatus receives both the transmitted signal and a reflection of the transmitted signal as reflected by the object to be sensed. The signal may be transmitted to the sensing node using backhaul signaling or radio resource configuration (RRC) signaling, for example.

The method 1800 may also involve transmitting an indication of the minimum value and/or a value to which the amplitude of a sample is to be set (which may or might not be the same). This may be particularly appropriate when the method 1800 is implemented for bistatic sensing. The indication may be transmitted using backhaul signaling or RRC signaling, for example.

The method 1800 may, for example, involve transmitting an indication of the minimum value to a receiving apparatus that is expected to receive a reflection of the transmitted signal. This may be particularly appropriate when the method 1800 is performed for (e.g. as part of) bistatic sensing. For example, the first sensing node 1202 described above may transmit an indication of the minimum value to the second sensing node 1206. Transmitting the indication of the minimum value may involve transmitting the minimum value itself, a value related to the minimum value (e.g. the square root of the minimum value or a threshold for the amplitude itself), or an identifier of the minimum value. For example, the indication may include an index for a particular minimum value in a look-up table storing a plurality of minimum values and their corresponding indices. The particular minimum value may be identified (e.g. by the receiving apparatus) by looking up the index in the look-up table. In another example, the indication may comprise a particular sensing accuracy level (e.g. a sensing accuracy threshold or quality of service requirement) in a plurality of sensing accuracy levels, in which each of the plurality of sensing accuracy levels is associated with a respective minimum value.

In some examples, the method 1800 may involve receiving a reflected signal (e.g. an echo) comprising a reflection of the single carrier signal from an object. This may form part of a monostatic sensing method, for example. The method 1800 may also involve determining a sensing estimate for the object based on the reflected signal and the frequency domain representation of the single carrier signal. Determining the sensing estimate for the object may involve determining at least one of: a distance to the object, a direction of the object, and movement of the object. The determination of the sensing estimate may be performed in accordance with the determination of a sensing estimate described above in respect of FIG. 12.

In general, the reflected signal may include one or more (e.g. more than one) reflected signals. In some examples, the method 1800 may involve receiving a plurality of reflected signals comprising reflections of the single carrier signal from a plurality of objects. The methods described herein may be used to sense (e.g. detect) multiple objects at the same time. As aspects of the present disclosure improve the ambiguity function of single carrier signals, this can help localize each reflection, preventing strong reflections (e.g. strong echoes) from interfering with weak reflections (e.g. weak echoes), allowing multiple objects to be sensed at once. The method 1800 may thus involve determining, for each of a plurality of objects, a sensing estimate based on a respective reflected signal comprising a reflection of the single carrier signal from a respective object in the plurality of objects.

In some examples, determining the sensing estimate may involve performing a Fourier transform on the reflected signal to obtain a frequency domain representation of the reflected signal (e.g. in accordance with step 1402 described above) and dividing the frequency domain representation of the reflected signal by the frequency domain representation of the single carrier signal (e.g. in accordance with step 1406 described above). An inverse Fourier transform may be performed on the divided signal in order to obtain a time domain signal (e.g. in accordance with step 1408 described above). In some examples, an RRC window may be applied to the frequency domain representation of the reflected signal before division (e.g. in accordance with step 1404 described above).

In a further aspect, an apparatus configured to perform the method 1800 is also provided. The apparatus may include a processor and a memory (e.g. a non-transitory processor-readable medium). The memory stores instructions (e.g. processor-readable instructions) which, when executed by a processor of an apparatus, cause the apparatus to perform the method 1800. In another aspect, the memory may be provided (e.g. separate to the apparatus).

It will be appreciated that the method 1800 is an example of how aspects of the present disclosure may be implemented. In other examples, some of the steps of the method 1800 may be omitted, modified and/or performed in a different order.

FIG. 19 shows a flowchart of a method 1900 according to embodiments of the disclosure. The method 1900 may be performed by a sensing node such as the first sensing node 1202 (e.g. in monostatic sensing) and/or the second sensing node 1206 (e.g. in bistatic sensing), for example. In some embodiments, the method 1900 may be performed by a processor, such as a processor of the second sensing node 1206. In general, the method 1900 may be performed by any suitable apparatus, or a processor of the apparatus. In some embodiments, the method 1900 may be distributed across (e.g. performed by) more than one apparatus.

The method 1902 may involve, in step 1902, receiving an indication of a minimum value. The minimum value is described in more detail below. The indication may be received via dynamic or semi-static signaling, for example. The indication may be received via backhaul signaling or radio resource RRC signaling, for example.

Receiving the indication of the minimum value may involve receiving the minimum value itself, a value related to the minimum value (e.g. the square root of the minimum value), or an identifier of the minimum value. For example, the indication may include an index for a particular minimum value in a look-up table storing a plurality of minimum values and their corresponding indices. The method may involve determining the particular minimum value by looking up the index in the look-up table. In another example, the indication may comprise a particular sensing accuracy level (e.g. a sensing accuracy threshold or quality of service requirement) in a plurality of sensing accuracy levels, in which each of the plurality of sensing accuracy levels is associated with a respective minimum value.

Step 1902 may be performed each time the method 1902 is performed. That is, an indication of a minimum value may be received each time a reflected signal is received. Alternatively, the indication of the minimum value may be received, for example, only when the minimum value changes. In some examples, step 1902 may be omitted entirely. This is discussed in more detail below.

The method 1900 involves, in step 1904, receiving a reflected signal comprising a reflection of a single carrier signal from an object. The reflected signal may alternatively be referred to as an echo. The object may be any object from which the signal may reflect, such as the object 1204.

The single carrier signal may be a single carrier radio signal. The single carrier signal may comprise any of the single carrier signals described above. The single carrier signal may comprise, for example, a DFT-S-OFDM signal, an SC-OQAM signal or an SC-OQPSK signal. The single carrier signal may be referred to as a sensing signal. The single carrier signal may include a communication signal. In particular examples, the single carrier signal may include an ISAC signal.

In step 1906, a frequency domain representation of the single carrier signal (e.g. of the signal that was originally transmitted) is obtained. The frequency domain representation of the single carrier signal includes one or more samples of the single carrier signal at respective subcarriers. A (e.g. at least one) sample in the one or more samples has an amplitude (e.g., an amplitude that has been set to a larger amplitude) such that a power of the respective sample is no less than the minimum value. For example, the reflected signal may include a reflection of a signal transmitted in accordance with the method 1800.

Obtaining the frequency domain representation of the single carrier signal may involve receiving the frequency domain representation of the single carrier signal (e.g. from another apparatus, such as a sensing node). For example, the frequency domain representation of the single carrier signal may be received from the apparatus that transmitted the single carrier signal towards the object (e.g. an apparatus that performed the method 1900). The signal may be received via backhaul signaling or RRC signaling, for example. In examples in which the frequency domain representation of the single carrier signal is obtained by receiving the frequency domain representation of the single carrier signal, step 1902 may be omitted.

Alternatively, the method 1900 may involve processing the reflected signal to obtain the frequency domain representation of the single carrier signal. The processing may involve one or more of the following: performing a Fourier transform on the reflected signal (e.g. in accordance with step 1602 and/or 1614 described above), applying an RRC window to the reflected signal (e.g. in accordance with step 1604 described above), equalizing the reflected signal (e.g. in accordance with step 1606 described above), performing an inverse Fourier transform (e.g. in accordance with step 1608 described above), FEC decoding (e.g. in accordance with step 1610 described above), encoding and I/Q mapping (e.g. in accordance with step 1612 described above), and setting an amplitude of at least one of the samples to a larger value (e.g. in accordance with step 1616 described above).

Setting an amplitude of at least one of the samples to a larger value may involve setting the amplitude of the respective sample to the larger amplitude such that the power of the respective sample is no less than the minimum value. The minimum value may have been received in step 1902. For example, the second sensing node 1206 described above may receive an indication of the minimum value from the first sensing node 1202. Receiving the minimum value may be particularly appropriate in embodiments in which there are multiple potential minimum values that can be used.

Setting an amplitude of at least one of the samples to a larger value may involve, for each sample in the one or more samples, setting the amplitude of the respective sample to the larger amplitude such that a power of the respective sample is no less than (e.g. is greater than, or greater than or equal to) the minimum value. Each sample may be set to the same amplitude (e.g. to a square root of the minimum value) or a respective (e.g. different) amplitude. In some examples, step 1906 may involve setting the amplitude of a respective sample according to:

$${x}_{i} = \sqrt{ρ} {e}^{j {θ}_{i ,}}$$

in which θᵢ is a phase of the respective sample xᵢ and ρ is the minimum value.

In yet a further alternative, obtaining the frequency domain representation of the single carrier signal may involve receiving the single carrier signal (e.g. from another device or apparatus) and performing a Fourier transform on the single carrier signal to obtain the frequency domain representation of the single carrier signal.

In step 1908, a sensing estimate is determined based on the reflected signal and the frequency domain representation of the single carrier signal. Determining the sensing estimate for the object comprises determining at least one of: a distance to the object, a direction of the object, and movement of the object. The determination of the sensing estimate may be performed in accordance with the determination of a sensing estimate described above in respect of FIGS. 12 and 14-16.

In some examples, determining the sensing estimate may involve performing a Fourier transform on the reflected signal to obtain a frequency domain representation of the reflected signal (e.g. in accordance with step 1602 described above) and dividing the frequency domain representation of the reflected signal by the frequency domain representation of the single carrier signal (e.g. in accordance with step 1618 described above). In some examples, an RRC window may be applied to the frequency domain representation of the reflected signal before division (e.g. in accordance with step 1604 described above).

The above description of the method 1900 refers to a reflected signal reflected from an object. In general, the reflected signal may include one or more (e.g. more than one) reflected signals. In some examples, the method 1900 may involve receiving a plurality of reflected signals comprising reflections of the single carrier signal from a plurality of objects. The methods described herein may be used to sense (e.g. detect) multiple objects at the same time. As aspects of the present disclosure improve the ambiguity function of single carrier signals, this can help localize each reflection, preventing strong reflections (e.g. strong echoes) from interfering with weak reflections (e.g. weak echoes), allowing multiple objects to be sensed at once. For example, step 1908 may involve determining, for each of a plurality of objects, a sensing estimate based on a respective reflected signal comprising a reflection of the single carrier signal from a respective object in the plurality of objects.

In a further aspect, an apparatus configured to perform the method 1900 is also provided. The apparatus may include a processor and a memory (e.g. a non-transitory processor-readable medium). The memory stores instructions (e.g. processor-readable instructions) which, when executed by a processor of an apparatus, cause the apparatus to perform the method 1900. In another aspect, the memory may be provided (e.g. separate to the apparatus).

It will be appreciated that the method 1900 is an example of how aspects of the present disclosure may be implemented. In other examples, some of the steps of the method 1900 may be omitted, modified and/or performed in a different order.

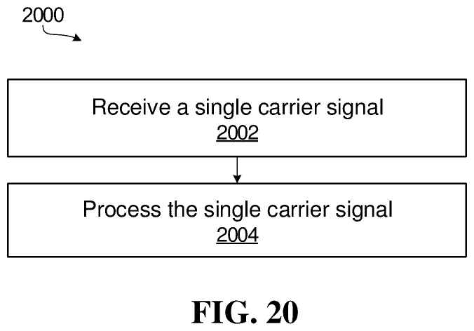

FIG. 20 shows a flowchart of a method 2000 according to embodiments of the disclosure. The method 2000 may be performed an apparatus (e.g. device) capable of receiving a single carrier signal. The method 2000 may be performed by a communication device, such as a network node or an electronic device. The method 1200 may be performed by an object such as the object 1204, for example. In some embodiments, the method 2000 may be performed by a processor, such as a processor of the object 1204 described above. In general, the method 2000 may be performed by any suitable apparatus, or a processor of the apparatus. In some embodiments, the method 2000 may be distributed across (e.g. performed by) more than one apparatus.

The method 2000 may involve, in step 2002, receiving a single carrier signal. The single carrier signal may be a single carrier radio signal. The single carrier signal may comprise any of the single carrier signals described above. The single carrier signal may comprise, for example, a DFT-S-OFDM signal, a SC-OQAM signal or a SC-OQPSK signal. The single carrier signal may include a sensing signal. The single carrier signal may include a communication signal. In particular examples, the single carrier signal may include an ISAC signal.

The single carrier signal may have been processed in the frequency domain prior to transmission. In the frequency domain, the single carrier signal may include one or more samples of the single carrier signal at respective subcarriers. The frequency domain representation of the single carrier signal may have been processed, prior to transmission, to set an amplitude of a particular sample in the one or more samples to a larger amplitude such that a power of the respective sample was no less than a minimum value. In some examples, each of the samples of the frequency domain representation of the single carrier signal may have been set to the same amplitude. For example, the amplitude of each sample xᵢ having a respective phase θᵢ may have been set according to:

$${x}_{i} = \sqrt{ρ} {e}^{j {θ}_{i}} ,$$

in which ρ is the minimum value.

The single carrier signal may have been processed prior to transmission in accordance with step 1802 described above, for example. In particular examples, the single carrier signal may have been floor clipped in accordance with any of the methods of floor clipping described above.

The method 2000 may end after step 2002. Alternatively, the method 2000 may proceed to step 2004, in which the received signal may be processed. It will be appreciated that there are various ways in which the received single carrier signal may be processed.

In particular examples, the received signal may be processed to detect a communication signal. The communication signal may include data and/or a control signal such as a reference signal or a synchronization signal. Processing the received signal to detect a communication signal may involve one or more of: performing a Fourier Transform on the received signal (e.g. as in step 1702) to obtain a frequency domain representation of the received signal, equalizing the frequency domain representation of the received signal (e.g. as in step 1704), performing an inverse Fourier transform on the equalized frequency domain representation of the received signal (e.g. as in step 1706) and decoding the received signal (e.g. as in step 1708).

The detected communication signal may be used for one or more purposes, such as any of the purposes described above in respect of the method 1700. For example, the detected communication may be used for one or more of: CSI measurement, CSI updating, CSI monitoring, beam tracking, beam management measurement, etc.

In some examples, the method 2000 may involve obtaining the minimum value. The minimum value may be used for processing of the received signal. The minimum value may be preconfigured. Thus, obtaining the minimum value may involve retrieving the minimum value from memory. Alternatively, the method 2000 may involve receiving an indication of the minimum value (e.g. using any of the approaches described above in step 1902).

In a further aspect, an apparatus configured to perform the method 2000 is also provided. The apparatus may include a processor and a memory (e.g. a non-transitory processor-readable medium). The memory stores instructions (e.g. processor-readable instructions) which, when executed by a processor of an apparatus, cause the apparatus to perform the method 2000. In another aspect, the memory may be provided (e.g. separate to the apparatus).

It will be appreciated that the method 2000 is an example of how aspects of the present disclosure may be implemented. In other examples, some of the steps of the method 2000 may be omitted, modified and/or performed in a different order.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

What is claimed is:

1. A method comprising:
generating a single carrier signal for transmission; and
processing the single carrier signal based on a frequency domain representation of the single carrier signal, to obtain a processed single carrier signal, wherein a frequency domain representation of the processed single carrier signal comprises one or more samples of the processed single carrier signal at respective subcarriers of the single carrier, a sample of the one or more samples having an amplitude such that a power of the respective sample is no less than a minimum value; and
outputting the signal for transmission.

2. The method of claim 1, wherein processing the signal carrier signal comprises:
performing a Fourier transform on the single carrier signal to obtain the frequency domain representation of the single carrier signal; and
increasing the amplitude of the sample of the one or more samples.

3. The method of claim 2, wherein the respective sample xᵢ has a phase θᵢ, and increasing the amplitude of the sample comprises setting the amplitude of the respective sample to a larger amplitude such that the power of the respective sample is no less than the minimum value ρ, by setting the amplitude of the respective sample according to:
$${x}_{i} = \sqrt{ρ} {e}^{j {θ}_{i}} .$$

4. The method of claim 1, wherein processing the single carrier signal further comprises:
applying a root raised-cosine window to the frequency domain representation of the single carrier signal.

5. The method of claim 1, further comprising:
receiving a reflected signal comprising a reflection of the processed single carrier signal from an object; and
determining a sensing estimate for the object based on the reflected signal and the frequency domain representation of the processed single carrier signal.

6. The method of claim 5, wherein determining the sensing estimate based on the reflected signal and the frequency domain representation of the processed single carrier signal comprises:
performing a Fourier transform on the reflected signal to obtain a frequency domain representation of the reflected signal; and
dividing the frequency domain representation of the reflected signal by the frequency domain representation of the processed single carrier signal.

7. A method comprising:
receiving a reflected signal comprising a reflection of a single carrier signal from an object;
obtaining a frequency domain representation of the single carrier signal, wherein the frequency domain representation of the single carrier signal comprises one or more samples of the single carrier signal at respective subcarriers of the single carrier, a sample of the one or more samples having an amplitude such that a power of the respective sample is no less than a minimum value;
determining a sensing estimate based on the reflected signal and the frequency domain representation of the single carrier signal.

8. The method of claim 7, wherein determining the sensing estimate based on the reflected signal and the frequency domain representation of the single carrier signal comprises:
performing a Fourier transform on the reflected signal to obtain a frequency domain representation of the reflected signal; and
dividing the frequency domain representation of the reflected signal by the frequency domain representation of the single carrier signal.

9. The method of claim 7, wherein obtaining the frequency domain representation of the single carrier signal comprises:
for each of the one or more samples, setting the amplitude of the respective sample to a larger amplitude such that the power of the respective sample is no less than the minimum value.

10. The method of claim 9, wherein each respective sample xᵢ has a phase θᵢ and wherein setting the amplitude of the respective sample to the larger amplitude such that the power of the respective sample is no less than the minimum value ρ comprises setting the amplitude of the respective sample according to:
$${x}_{i} = \sqrt{ρ} {e}^{j {θ}_{i}} .$$

11. An apparatus comprising:
at least one processor; and
a memory storing instructions which, when executed by the at least one processor, cause the apparatus to:
generate a single carrier signal for transmission;
process the single carrier signal based on a frequency domain representation of the single carrier signal, to obtain a processed single carrier signal, wherein a frequency domain representation of the processed single carrier signal comprises one or more samples of the processed single carrier signal at respective subcarriers of the single carrier, a sample of the one or more samples having an amplitude such that a power of the respective sample is no less than a minimum value; and
output the processed single carrier signal for transmission.

12. The apparatus of claim 11, wherein, when the instructions are executed by the at least one processor, the process the single carrier signal, the apparatus is caused to:
perform a Fourier transform on the single carrier signal to obtain the frequency domain representation of the single carrier signal; and
increase the amplitude of the sample of the one or more samples.

13. The apparatus of claim 11, wherein the respective sample xᵢ has a phase θᵢ and wherein, when the instructions are executed by the at least one processor to cause the apparatus to increase the amplitude of the sample, the apparatus is caused to set the amplitude of the respective sample to a larger amplitude such that the power of the respective sample is no less than the minimum value ρ, by setting the amplitude of the respective sample according to:
$${x}_{i} = \sqrt{ρ} {e}^{j {θ}_{i}} .$$

14. The apparatus of claim 11, wherein, when the instructions are executed by the at least one processor, to cause the apparatus to process the single carrier signal, the apparatus is caused to:
apply a root raised-cosine window to the frequency domain representation of the single carrier signal.

15. The apparatus of claim 11, wherein, when the instructions are executed by the at least one processor, the apparatus is further caused to:
receive a reflected signal comprising a reflection of the processed single carrier signal from an object; and
determine a sensing estimate for the object based on the reflected signal and the frequency domain representation of the processed single carrier signal.

16. The apparatus of claim 15, wherein, when the instructions are executed by the at least one processor, the apparatus is caused to determine the sensing estimate based on the reflected signal and the frequency domain representation of the single carrier signal by:
performing a Fourier transform on the reflected signal to obtain a frequency domain representation of the reflected signal; and
dividing the frequency domain representation of the reflected signal by the frequency domain representation of the single carrier signal.

17. An apparatus comprising:
at least one processor; and
a memory storing instructions which, when executed by the at least one processor, cause the apparatus to:
receive a reflected signal comprising a reflection of a single carrier signal from an object;
obtain a frequency domain representation of the single carrier signal, wherein the frequency domain representation of the single carrier signal comprises one or more samples of the single carrier signal at respective subcarriers of the single carrier, a sample of the one or more samples having an amplitude such that a power of the respective sample is no less than a minimum value; and
determine a sensing estimate based on the reflected signal and the frequency domain representation of the single carrier signal.

18. The apparatus of claim 17, wherein when the instructions are executed by the at least one processor, the apparatus is caused to determine the sensing estimate based on the reflected signal and the frequency domain representation of the single carrier signal by:
performing a Fourier transform on the reflected signal to obtain a frequency domain representation of the reflected signal; and
dividing the frequency domain representation of the reflected signal by the frequency domain representation of the single carrier signal.

19. The apparatus of claim 17, wherein when the instructions are executed by the at least one processor, the apparatus is caused to obtain the frequency domain representation of the single carrier signal by:
setting the amplitude of each respective sample of the one or more samples to a larger amplitude such that the power of the respective sample is no less than the minimum value.

20. The apparatus of claim 19, wherein each respective sample xᵢ has a phase θᵢ and wherein when the instructions are executed by the at least one processor, the apparatus is caused to set the amplitude of each respective sample to the larger amplitude such that the power of the respective sample is no less than the minimum value ρ by setting the amplitude of the respective sample according to:
$${x}_{i} = \sqrt{ρ} {e}^{j {θ}_{i}} .$$
